(19) United States
(12) Patent Application Publication
(10) Pub. No.: US 2026/0303604 A1
(43) Pub. Date: Oct. 1, 2026

(54) SYSTEMS AND METHODS FOR GENERATING DIALOGUE-BASED AUDIO MEDIA USING A GENERATIVE SERVICE AND USER-GENERATED CONTENT OF A CONTENT COLLABORATION PLATFORM

(71) Applicant: Atlassian Pty Ltd., Sydney (AU)

(72) Inventors: Jasmine Ang, San Francisco, CA (US); John Hooper, San Francisco, CA (US); Saurav Shekhar, San Jose, CA (US); Brandon Roher, Boston, MA (US)

(21) Appl. No.: 19/094,749

(22) Filed: Mar. 28, 2025

(51) Int. Cl. H04L 9/40

(52) U.S. Cl. CPC H04L 63/102; H04L 63/105

(57) ABSTRACT

Embodiments described herein relate to systems and methods for generating a generative dialogue-based audio based on pages from a content collaboration platform. The method may include obtaining page content, analyzing the page content to obtain related pages, related data items, user roles, and other user-specific information. The obtained content and context is subject to a respective permissions scheme. A prompt is then generated and submitted to a generative output engine, the prompt includes a request to generate a multi-speaker content stream, the page content and other context obtained from the related data items and user information. The generated multi-speaker content stream may be used to generate an audio object from the generative dialogue-based audio based on the multi-speaker content stream.

### TECHNICAL FIELD

Embodiments described herein relate to collaborative work environments and, in particular, to systems and methods for converting pages and other content associated with collaborative work environments into generative dialogue-based audios.

### BACKGROUND

Collaborative work environments and, specifically, content collaboration platforms are useful tools in which users can create and collaborate on content, such as electronic pages. Electronic pages in content collaboration platforms are uniquely intertwined. For example, pages may link or refer to other pages and/or may draw live content from other pages. In many cases, electronic pages build on information from another user's electronic page. As a result, a large amount of data (and pages) are usually created and updated dynamically, hampering many users'ability to read all the pages that may be of interest and/or use. Similarly, reviewing and reading a large number of pages is taxing for users'health due to the increase in screen time and time sitting.

### SUMMARY

A computer implemented method for generating a generative dialogue-based audio file based on pages from a content collaboration platform, such as described herein, may include: subsequent to a successful authentication of a first user account for a user of a frontend application of a content collaboration platform and in accordance with a first permissions condition being satisfied with respect to the user account and a first page, causing display of a graphical user interface in the frontend application, the graphical user interface including a document view region including user-generated content of the first page; in response to receiving a request to generate a generative dialogue-based audio file at the graphical user interface, extracting the user-generated content of the first page to define a first content portion and first permissions data of the first page; analyzing the user-generated content of the first page to identify a content item embedded within the first page, the content item having linked content with respect to a second page; in accordance with a second permissions condition being satisfied with respect to the authenticated user account and the content item, extracting content from the content item to define a second content portion and a second permissions data of the content item; evaluating the first content portion of the first page and the second content portion of the content item with respect to a generative dialogue-based audio generation criteria. In some cases, in accordance with the first content portion and second content portion satisfying the generative dialogue-based audio file generation criteria, generating a prompt, the prompt having: predetermined query prompt text including instructions to generate a multi-speaker content stream; context information extracted from the first page and the content item; the first content portion extracted from the first page; and the second content portion extracted from the content item. In response to providing the prompt to a generative output engine, receiving a first generative output from a first generative output engine, the first generative output comprising the multi-speaker content stream; constructing a request to generate the generative dialogue-based audio file based on the multi-speaker content stream; In response to the request to generate the generative dialogue-based audio file, receiving the generative dialogue-based audio file; generating an aggregated permissions profile based on the first permissions data and a second permissions data; generating an audio object within a document of the content collaboration platform, the audio object including the aggregated permissions profile and the generative dialogue-based audio file; and in accordance with a permissions profile associated with the second authenticated user satisfying the aggregated permissions conditions associated with the audio object, causing the audio object to be executed within a respective graphical user interface of a respective frontend application.

In some embodiments, the method also includes obtaining a user profile associated with the user account, extracting one or more profile attributes from the user profile, the one or more profile attributes including a user role, and where: the multi-speaker content stream includes a narrative exchange between two or more entities; and the prompt further comprises text based on the one or more profile attributes. In some cases, the content item is a first content item. The method may also include analyzing the user-generated content of the first page to identify a second content item embedded within the first page, the second content item having linked content with respect to an issue item of an issue tracking platform; in accordance with a fourth permissions condition being satisfied with respect to the first authenticated user account, the issue tracking platform, and the second content item, extracting content from the second content item to define a third content portion and a third permissions data of the second content item; evaluating the third content portion in accordance with the generative dialogue-based audio file generation criteria. In some cases, the prompt further includes the third content portion extracted from the issue item and the aggregated permissions profile comprises a least permissive scheme based on permissions condition associated with the first page or the content item.

In some examples, the method includes identifying a change to the first permissions data associated with the first page, in response to identifying the change, updating the aggregated permissions profile to generate a new aggregated permissions profile based on the first permissions data, and updating the audio object in accordance with the new aggregated permissions profile. In some examples, the method may include identifying a first segment of the audio object associated with the first page, identifying a second segment of the audio object associated with the second page, and tagging the first segment and the second segment of the audio object, the tagging configured to be displayed within the graphical user interface of the respective frontend application in accordance with its respective source.

In some cases, the method may include, in accordance with the third authenticated user account failing the aggregated permissions associated with the audio object, suppressing playback of the audio object within the respective graphical user interface of the respective frontend application. In some examples, the generative output engine is configured to produce two different speakers for different portions of the input to generate a simulated dialogue.

In some embodiments described herein a method for generating a generative dialogue-based audio file based on a particular page in a content collaboration platform may include: in response to permissions associated with an authenticated user account satisfying a first permissions condition with respect to the particular page, causing display of a graphical user interface in a frontend application of a content collaboration platform, the graphical user interface comprising a navigation panel having a plurality of hierarchically-arranged tree elements and a content region configured to display document content; receiving a request to generate a generative dialogue-based audio file based on the particular page in the content collaboration platform; identify a plurality pages in a document space associated with the particular page, the plurality of pages identified based on respective content for each page of the plurality of page satisfying a relatedness criteria; for each page of the plurality of pages, verifying that a respective second permissions condition is satisfied; selecting a set of secondary pages from the plurality of pages based on the relatedness criteria and extract a portion of the content from each respective secondary page of the set of secondary pages; retrieving user information associated with the authenticated user, the user information comprising a plurality of profile attributes. In some cases, a prompt for submitting to a first generative output engine may be constructed which includes: the portion of page content from the particular page; the portion of page content from each secondary page of the set of secondary pages; at least one profile attribute from the plurality of profile attributes; and a predetermined query prompt text comprising a set of constraints for generating a multi-speaker content stream; in response to providing the prompt to the first generative output engine, receiving a first generative output comprising the multi-speaker content stream; generating a request to generate a generative dialogue-based audio file comprising the multi-speaker content stream; in response to the request, receiving the generative dialogue-based audio file output from a second generative output engine; analyzing at least a segment of the generative dialogue-based audio file output to identify a first segment of the generative dialogue-based audio file that includes content corresponding to the particular page. An audio object may be constructed, which includes the generative dialogue-based audio file and a plurality of tags. The plurality of tags may include a first tag corresponding to the particular page and associated with the first permissions condition, the first tag attached to a first segment of the audio object; and a plurality of second tags corresponding to the each secondary page of the set of secondary pages and associated with the respective second permissions condition, each second tag of the plurality of second tags attached to a respective second segment of the audio object. The method may also include causing the audio object to be executed by an audio player, the audio player comprising an audio player interface displayed within the graphical user interface of the frontend application and configured to play the first segment of the audio object and the respective second segment of the audio object upon a particular user satisfying permissions conditions associated with the first tag and the plurality of second tags.

In some cases, at least one set of user event logs associated with an interaction between the user and the content collaboration platform may be retrieved and, in accordance with the at least one set of user event logs including a page edit-or a page creation-user event type with respect to a second page from the set of secondary pages, content from the second page may be excluded from the prompt. In some cases, in accordance with an authenticated account associated with a different user failing permissions conditions associated with the plurality of second tags, the second segment may be skipped.

In some examples, the method may also include: identifying a graphical user element within the portion of page content from the particular page, the graphical user element comprising linked content to a third page; in accordance with a third permissions condition being satisfied with respect to the user account and the third page, extracting a portion of page content from the third page; and hydrating the prompt to include the portion of page content from the third page.

In some cases, the method includes generating a personality profile for at least one entity of the multi-speaker content stream, the personality profile based on a user role extracted from the user information, and generating a speaker voice requirement for the generative dialogue-based audio file from a user geographical location extracted from the user information. The prompt may also include the personality profile and the request to generate the generative dialogue-based audio file may include the speaker voice requirement, the speaker voice requirement including a language or a speaker accent. In some examples, the audio object is added as a multimedia item within the particular page.

In some examples, an edited portion of the particular page since the generative dialogue-based audio file was generated may be identified. It may be determined that the edited portion satisfies a modification threshold and, in response to determining that the edited portion satisfies the modification threshold, a warning adjacent to the multimedia item may be generated, the warning indicating a change with respect to the edited portion. The prompt may be updated to include the edited portion and an updated audio object may be automatically generated, the updated audio object based on an updated multi-speaker content stream received in response to the updated prompt provided to the first generative engine.

Some examples described herein include a method for generating a generative dialogue-based audio file from pages in a content collaboration platform. The method may include: in response to permissions associated with an authenticated user account satisfying a first permissions condition with respect to a first page, causing display of the first page in a graphical user interface for the content collaboration platform; in response to a user selection of the first page for creating a generative dialogue-based audio file: generating a search phrase based on content extracted from the first page; identifying a plurality of pages within the content collaboration platform, wherein the set of user credentials satisfies at least a respective viewing permissions profile for each page of the plurality of pages; executing a search using the search phrase with respect to the plurality of pages in the content collaboration platform; and in response to the search, selecting and retrieving a subset of pages from the plurality of pages satisfying a relatedness criteria, the subset of pages returned from the search; for each retrieved page of the subset of pages, extracting respective content; generating a prompt having: predetermined query prompt text including instructions to generate a multi-speaker content stream; context information comprising the respective content from each retrieved page of the subset of pages; and the content extracted from the first page. In some cases, the method may also include: providing, to a first generative output engine, the prompt; receiving, from the first generative output engine, the multi-speaker content stream; in response to receiving the multi-speaker content stream, constructing a request to generate a generative dialogue-based audio file, the request comprising the multi-speaker content stream; in response to receiving the generative dialogue-based audio file, generating an audio object comprising an aggregated permissions profile and the generative dialogue-based audio file, the aggregated permissions profile based on the permissions profile with respect to the first page and the respective viewing permissions profile for each page of the subset of pages.

In some embodiments, the method may also include: analyzing the content to identify an issue ID associated with a graphical user element within the content of the first page; subsequent to the authenticated user account satisfying an issue item permissions profile with respect to an issue tracking platform and to an issue item corresponding to the issue ID, obtaining content from the issue item; evaluating content from the issue item in accordance to a generative dialogue-based audio generation criteria; and in response to the content from the issue item satisfying the generative dialogue-based audio generation criteria, hydrating the prompt to include the content from the issue item.

In some cases, the issue item is a child issue item, and the method may further include: analyzing a content graph to identify a parent issue item of the child issue item; subsequent to the authenticated user account satisfying a parent issue permissions profile, obtaining and evaluating content from the parent issue item in accordance to the generative dialogue-based audio generation criteria; and in response to the content from the parent issue item satisfying the generative dialogue-based audio generation criteria, hydrating the prompt to include the content from the parent issue item. In some examples, the request to generate the generative dialogue-based audio file further includes a target duration of the generative dialogue-based audio file. In some examples, the relatedness criteria includes pages within a same space and a semantic similarity threshold between the first page and another page.

In some examples, the user is a first user, the user selection is a first user selection and the first user selection is by the first user, the plurality of pages is a first plurality of pages, the subset of pages is a first subset of pages, and the audio object is a first audio object. The method may also include: in response to a second user selection by the second user of the first page for creating the generative dialogue-based audio file: identifying a second plurality of pages different from the first plurality of pages, wherein a second authenticated user account satisfies at least a respective viewing permissions profile for each page of the second plurality of pages; executing a second search using the search phrase with respect to the second plurality of pages; in response to the second search, selecting and retrieving a second subset of pages from the second plurality of pages satisfying the relatedness criteria; for each retrieved page of the second subset of pages, extracting respective content; updating the prompt comprising the respective content from each retrieved page of the second subset of pages; providing, to the first generative output engine, the updated prompt; receiving, from the first generative output engine, an updated multi-speaker content stream; in response to receiving the updated multi-speaker content stream, generating a second request for generate an updated generative dialogue-based audio file, the second request comprising the updated multi-speaker content stream; and in response to receiving an updated generative dialogue-based audio file, generating a second audio object comprising an updated aggregated permissions profile and the updated generative dialogue-based audio file, the updated aggregated permissions profile based on the permissions profile with respect to the first page and the respective viewing permissions profile for each page of the second subset of pages.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system that is configured to generate a generative dialogue-based audio from a page.

FIG. 2 depicts a functional system diagram that can be used to generate a generative dialogue-based audio from a page.

FIGS. 3A-3B depict example user interfaces of a content collaboration platform with a generative dialogue-based audio generation interface.

FIG. 4 depicts a system diagram and network/communication architectures that may support a system as described herein.

FIG. 5 depicts a functional system diagram of network/communication architectures that may support a system as described herein.

FIG. 6 depicts a simplified system diagram and data processing pipeline.

FIG. 7 depicts a system providing multiplatform prompt management as a service.

FIG. 8 shows a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems, devices, and methods for generating generative dialogue-based audios using content from user-generated pages (hereinafter “pages,” “electronic pages,” or “electronic documents”). As described herein, a dialogue-based audio generation service may cooperate with a prompt management service to invoke a generative output engine, which may include a large-language model or other similar generative content engine, to create a multi-speaker content stream based on the selected pages. The multi-speaker content stream may include written content that includes a conversion between two or more speakers about the pages. From the multi-speaker content stream, the generative dialogue-based audio may be created. The prompts provided to the generative responses may be constructed by leveraging data from the pages, user roles, user data events, page metadata, other platform content, and the like.

Generally, collaboration platforms can be used to generate, store, and organize user-generated content. Often, the large amount of content generated by users in content collaboration platforms is difficult to digest for many users. For example, many pages may include unfamiliar subject matter, many pages lack background for users that are not involved in the project, reading electronic pages may cause mental and eye fatigue, reading also causes a tendency to skim a page and miss important details, reading requires a sedentary state for users resulting in less exercise, and the like. On the other hand, audio media, such as podcasts, webcasts, talk shows, provide listeners digestible information that is engaging for many listeners, allowing the listeners to retain more information and stay engaged with a subject. However, given the volume of data in pages, users cannot practically create and record audio-based content for each page because audio creation for content is time-consuming and unsustainable for the users and for the system in general. Moreover, while access to pages is restricted to particular users (e.g., edit and view permissions), audio media generally is not under the same safeguards and thus may circumvent the permissions scheme of the pages, resulting in sensitive information potentially being disclosed.

As such, a collaboration platform may benefit from a service that generates a generative dialogue-based audio using content from pages and other contextual data that allows the user to digest information of a page as an engaged, active listener (e.g., while “on the go”) while maintaining an aggregated permissions profile based on the least permissive permissions scheme of its underlying content. For example, the generated generative dialogue-based audio may be accessible to users having which satisfy a respective permissions condition of each of the underlying page(s) from which information was obtained to generate the generative dialogue-based audio. In some cases, the generative dialogue-based audio may be available only to the user which requests the generation of the generative dialogue-based audio for a particular page(s) and the pages used by the generative dialogue-based audio service may suppress pages for which the user's permission profile does not satisfy the respective permissions condition for each page.

More specifically, a dialogue-based audio generation service may be employed to obtain a portion of content from a page (e.g., a page selected by a user which the user wants to hear in audio form); analyze the portion of content to identify content items embedded within the page which may include linked content with respect to other pages, other platforms, or other users; and extracting the linked content items once permissions conditions have been satisfied with respect to the linked content item. A prompt may be constructed using portions of the content, context from the linked content items, and predetermined text including instructions for generating the multi-speaker stream. This multi-speaker stream may be output by a generative engine based on the prompt and, in turn, used as input for a request to generate a generative dialogue-based audio file. The request to generate a generative dialogue-based audio file may be provided to a text-to-speech (TTS) engine, such as a TTS LLM, which outputs the generative dialogue-based audio.

In some examples described herein, the linked content items may be displayed as graphical user elements. Each of the graphical user elements may be operable to redirect a user to linked content, such as another page, an issue item, a project, and the like. The graphical user element may include a preview of the content and/or metadata obtained from the linked content. A dialogue-based audio generation service may identify these graphical user elements as an editor-specific object including structured rich text or encoded rich text. The service may be configured to remove identified the rich text from the portion of the content to provide to the prompt and analyze the content of the element to extract linked content. In some cases, prior to obtaining linked content, a permissions profile of a user may be verified against the permissions conditions associated with linked content. The extracted linked content may be used as additional context for the prompt and may be provided in text form or in other LLM-supported formats.

In some cases, context may be included based on a relatedness criteria between the page and other pages or other platform content. For example, a relatedness criteria may be based on a page's hierarchical structure within a page tree of a particular space, such as parent-child relationship of the page, semantic similarity, position within the page, and/or duplication of content between pages.

In some cases, the prompt may be further preconditioned and/or hydrated with information on a user. In particular, a user profile associated with the content collaboration platform and/or with a suite of platforms may be obtained. Based on the user profile, one or more profile attributes (e.g., user role, user location, enterprise), and/or one or more user event logs may be extracted. This information may be used as context to the generative engine. By providing context, the multi-speaker content stream may be more tailored to the requesting user. For example, a user's role may be used as a proxy for level of detail, knowledge on a subject, and the like. As another example, user event logs may be leveraged to provide context regarding level of familiarity with a topic a user has and/or to generate a generative dialogue-based audio that reduces the amount of duplicate information a user is already familiar with based on previous pages the user has edited and/or read, for example. In some cases, a geographical information of the user may be used to specify a speaker accent and/or other geographically-specific idiosyncrasies that may be used to generate generative dialogue-based audio.

In some cases, a generative dialogue-based audio generation criteria is applied by the dialogue-based audio generation service for each page that is provided to the prompt. In some cases, the generative dialogue-based audio generation criteria may be based on a minimum amount of content (e.g., text and multimedia) for generating a generative dialogue-based audio, substantive content of the page (e.g., informational vs. task-based), or text vs. numbers (e.g., pages with extensive tables of numbers may not satisfy the criteria).

According to some examples, the dialogue-based audio generation service may be configured identify portions of the multi-speaker content stream and corresponding segments of the generative dialogue-based audio having information from the underlying page or content item from which the information was received. In some cases, an audio object may be constructed that includes the output generative dialogue-based audio and a plurality of tags, each tag corresponding to each respective page. For example, minute fifty two through sixty of the audio output may include discussion of a particular page. In this example, this eight minute chunk may be tagged as having content from a particular page. Due to this tagging system, if a particular user's permissions profile does not satisfy the permissions condition associated with the particular page, minute fifty two through sixty may be skipped or otherwise redacted for the particular user. In some cases, different versions of the generative dialogue-based audio may be generated in accordance with different users'permissions profiles and thus each multi-speaker content stream may draw content from different pages. In some embodiments, an aggregated permissions profile may be generated, which may adopt a least permissive permissions condition from the underlying permissions conditions for each of the pages. Users failing the least permissive permissions conditions may not access the audio object.

As used herein, the terms “collaboration platform” or “collaboration service” may refer to a documentation platform or service configured to manage electronic documents or pages created by the system users, an issue tracking platform or service that is configured to manage or track issues or tickets in accordance with an issue or ticket workflow, a source code management platform or service that is configured to manage source code and other aspects of a software product, a manufacturing resource planning platform or service configured to manage inventory, purchases, sales activity or other aspects of a company or enterprise.

The examples provided herein are described with respect to a generative dialogue-based audio generator for content associated with the collaboration platform. In some instances, the functionality described herein may be adapted to multiple platforms or adapted for cross-platform use. For example, a set of host services or platforms may be accessed through a common gateway or using a common authentication scheme, which may allow a user to transition between platforms and access platform-specific content without having to enter user credentials for each platform. The foregoing embodiments are not exhaustive of the manners by which generative dialogue-based audios may be created.

### Scalable Network Architecture for Automatic Content Generation

Systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input.

In some examples, the user may engage with a button in a UI that causes the generative interface panel or a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands—after the user types a slash character, any text input after the slash character can be considered as a command to instruct the underlying system to perform a task.

Regardless of how a software platform user interface is instrumented to receive user input, the user may provide an input that indicates a page or group of pages for which a generative dialogue-based audio is requested. Based on this request and other contextual information from a user profile, a prompt may be generated and provided as input to an input queue including other requests from other users or other software platforms. Once the prompt is popped from the queue, it may be normalized and/or preconditioned by a preconditioning service. The preconditioning service may be provided by one or more registered plugins that are selected in accordance with an analysis of the input and/or context of the current session.

The preconditioning service can, without limitation: append additional context to the user's raw input; may insert the user's raw input into a template prompt selected from a set of prompts (also referred to herein as “predetermined query prompt text” or “predetermined prompt text”); replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### Large Language Models

An example of a generative output engine of a generative output system as described herein may be a large language model (LLM). An LLM may include a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phrase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. An LLM is typically trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation can be selected or generated using a number of techniques. In many cases, a continuation of an input prompt may be referred to more generally as “generated text” or “generated output” provided by a generative output engine as described herein.

Fundamentally all written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation. In addition, because punctuation and whitespace can serve as a portion of training data, generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt. For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM-generated output may insert cross-links to other content, such as other documents, other software platforms, or external resources such as websites.

In yet further examples, an LLM-generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href='https://example link/123456>project 123456</a>”. In addition, the LLM may be configured to replace the substring “pending” with a real-time updating token associated with an API call to the project management system. In this manner, the LLM converts a static string within the document management system into richer content that facilitates convenient and automatic cross-linking between software products, and may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilitates bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Transformer Architecture

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of attention mechanisms, including self-attention mechanisms, may be suitable.

In response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations. In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### Generative Output Engines & Generative Output Systems

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoint, such as for configuration or for receiving input prompts. The generative output application can be further configured to provide generated text output to one or more subscribers or API clients. Many suitable interfaces can be configured to provide input to and receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:
{
   “prompt”: “Generate five words of placeholder text in the English language.”,
   “API_KEY: “hx-Y5u4zx3kaF67AzkXK1hC”,
   “user_token”: “pkcLe7Co2g-50AoIVojGJ”
}

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:
{
   “response”: “Hello world text goes here.”,
   “generation_time_ms”: 2
}

In some embodiments, a prompt provided as input to a generative output engine can be engineered from user input. For example, in some cases, a user input can be inserted into an engineered template prompt that itself is stored in a database and includes text that may be referred to as predetermined query prompt text or predetermined prompt text. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### Prompt Pre-Configuration, Templatizing, & Engineering

As noted above, a prompt received from a user can be preconditioned and/or parsed to extract certain content therefrom. The extracted content can be used to inform selection of a particular engineered prompt template from a database of engineered prompt templates including predetermined query prompt text or predetermined prompt text. Once the selected prompt template is selected, the extracted content can be inserted into the template to generate a populated engineered prompt template that, in turn, can be provided as input to a generative output engine as described herein. Content extraction, prompt configuration, and prompt selection may be performed by a processing plugin that is registered or otherwise available to a generative service.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance,” “prompt preconditioning software instance,” “processing plugin,” or “plugin”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences.

For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on. For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:
{
   “raw_prompt”: summarize the edits to this page made by my team since I last visited this page”,
   “modified_prompt”: “Generate a summary of each paragraph tagged with an editId attribute matching editId=1, editId=51, editId=165, editId=99 within the following HTML-formatted content: [HTML-formatted content of the page].”
}

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:
{
   “snippet123_table_from_tasks”: “The table should be formatted as a three-column table with multiple rows. The leftmost column should be titled ‘Title’ and the corresponding content of each row of this column should be the title attribute of a task. The middle column should be titled ‘Created Date’ and the corresponding content of each row of this column should be the creation date of the task. The rightmost column should be titled ‘Status’ and the corresponding content of each row of this column should be the status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:
{
   “modified_prompt”: “Find all tasks assigned to User 1234 dating from Jan. 1, 2023-Jan. 14, 2023 (inclusive). Create a table in which each found task corresponds to a respective row of that table. The table should be formatted as a markdown table, in plain text, with three columns. The leftmost column should be titled ‘Title’ and the corresponding content of each row of this column should be the title attribute of a respective task. The middle column should be titled ‘Created Date’ and the corresponding content of each row of this column should be the creation date of the respective task. The rightmost column should be titled ‘Status’ and the corresponding content of each row of this column should be the status attribute of the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents.

In yet other examples, staging of requests may be useful for other purposes.

### Authentication & Authorization

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each page or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url”.

In yet other examples, a prompt engineering service may be configured to classify a user input into one of a number of classes of request. Different classes of request may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein. More generally, as noted above, a generative output engine may be a portion of a larger network and communications architecture as described herein. This network can include input queues, prompt constructors, engine selection logical elements, request routing appliances, authentication handlers and so on.

### Collaboration Platforms Integrated with Generative Output Systems

It may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multitenant software platform.

For simplicity of description, the multitenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform—multitenant or otherwise—as described herein are not collocated, and communicate over a large area and/or wide area network by leveraging one or more networking protocols, but this is not required of all implementations.

A frontend of a software platform as described herein may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multitenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third-party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multitenant software and, in particular, by a provider of suites of multitenant software platforms, each platform being configured for a different particular purpose. Herein, providers of systems or suites of multitenant software platforms are referred to as “multiplatform service providers.” Generally, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multitenant issue tracking system, a multitenant code repository service, and a multitenant documentation service. In this example, an organization that is a customer/client of the service provider may be a tenant of each of the issue tracking system, the code repository service, and the documentation service.

As with preceding examples, the organization can create and/or purchase user accounts for its employees, so that certain selected employees have access to one or more of issue tracking functionality, documentation functionality, and code repository functionality.

In this example and others, a system may leverage multiple collaboration tools to advance individual projects or goals. For example, for a single software development project, a software development team may use (1) a code repository to store project code, executables, and/or static assets, (2) a documentation service to maintain documentation related to the software development project, (3) an issue tracking system to track assignment and progression of work, and (4) a messaging service to exchange information directly between team members.

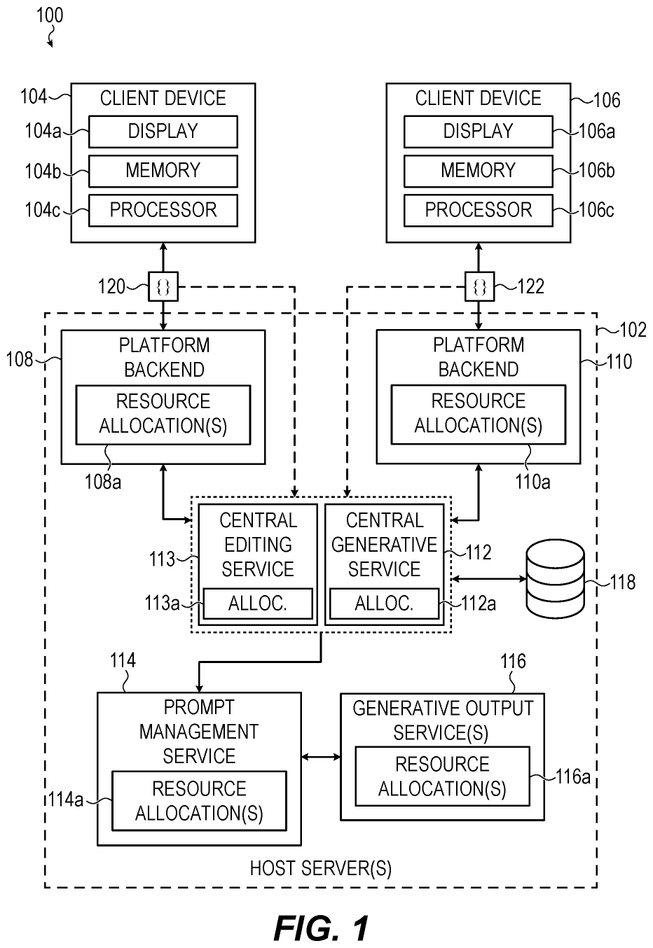

These foregoing and other embodiments are discussed below with reference to FIGS. 1-8. However, the detailed description given herein with respect to these figures is for explanation only and should not be construed as limiting.

### Dialogue-Based Audio Generation Services in Content Collaboration Platforms

FIG. 1 depicts a simplified diagram of a system, such as described herein, that can include and/or may receive input from a generative output engine to generate a multi-speaker content stream and a generative dialogue-based audio. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples include ITSM systems, chat platforms, messaging platforms, and the like. These backends can be communicably coupled to a generative output engine that can be leveraged to provide unique intelligent functionality to each respective backend. For example, the generative output engine can be configured to receive user prompts to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system, as well.

A user of the client devices may trigger production of generative output in a number of suitable ways. One example is shown in FIG. 1. In particular, in this embodiment, each of the software platforms can share a common feature, such as a common generative service, which may be rendered in a frame of the frontend user interfaces of both platforms.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each communicably couple to a centralized generative service 112.

The centralized generative service 112 can be configured to cause rendering of a frame or panel within respective frontends of each of the first platform backend 108 and the second platform backend 110. In this manner, and as a result of this construction, each of the first platform and the second platform present a consistent user content editing experience for accessing generative services including the automated assistant services and other operations described herein.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized generative service 112 that can be called by each respective frontend whenever it is required to present the user of that respective frontend with a generative interface that may facilitate a chat-based exchange with one or more automated assistant services.

The documentation platform's frontend may call upon the centralized generative service 112 to assist with content discovery and creation with respect to pages or documents managed by the documentation platform. Similarly, the issue tracking platform's frontend may call upon the centralized generative service 112 to perform content discovery, generation, and management of issues or tickets managed by the issue tracking platform.

The system 100 may also include a centralized content editing frame service 113, which can operate an editor or editing service for each of multiple platforms. More specifically, the centralized content editing frame service 113 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor. The centralized content editing frame service 113 can parse text input provided by users of the documentation platform frontend and/or the issue tracking platform backend, monitoring for command and control keywords, phrases, trigger characters, and so on. In many cases, for example, the centralized content editing frame service 113 can implement a slash command service that can be used by a user of either platform frontend to issue commands to the backend of the other system.

For example, the user of the documentation platform frontend can input a slash command to the content editing frame, rendered in the documentation platform frontend supported by the centralized content editing frame service 113, in order to type a prompt including an instruction to create a new issue or a set of new issues in the issue tracking platform. Similarly, the user of the issue tracking platform can leverage slash command syntax, enabled by the centralized content editing frame service 113, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; content editing elements can include and/or may be implemented to include many features, which may vary from embodiment to embodiment. For simplicity of description the embodiments that follow reference a centralized content editing frame service 113 configured for rich text editing, but it may be appreciated that this is merely one example.

In addition, as a result of the architectures described herein, services supporting the centralized content editing frame service 113 can be extended to include additional features and functionality—such as a slash command and control feature-which, in turn, can automatically be leveraged by any further platform that incorporates a content editing frame, and/or otherwise integrates with the centralized content editing frame service 113 itself. In this example, slash commands facilitated by the editor service can be used to receive prompt instructions from users of either frontend. These prompts can be provided as input to a prompt engineering/prompt preconditioning service (such as the prompt management service 114) that, in turn, provides a modified user prompt as input to a generative output service 116.

Similar functionality can also be provided by the centralized generative service 112. For example, as described herein the centralized generative service 112 may provide a chat-based interface in a panel or region of a frontend application. Through a series of natural language inputs, the system may provide content discovery, content modification, content generation, or content management operations. In some cases, the centralized generative service 112 utilizes a variety of software plugins and/or automated assistant services to provide the requested operations. The centralized generative service 112 may generate prompts, which, in this example, can be provided as input to a prompt engineering/prompt preconditioning service (such as the prompt management service 114) that, in turn, provides a modified user prompt as input to a generative output service 116.

The generative output service may be hosted over the host servers 102 or, in other cases, may be a software instance instantiated over separate hardware. In some cases, the generative engine service may be a third-party service that serves an API interface to which one or more of the host services and/or preconditioning service can communicably couple. The generative output engine can be configured as described above to provide any suitable output, in any suitable form or format. Examples include content to be added to user-generated content, API request bodies, replacing user-generated content, and so on.

The centralized content editing frame service 113 and/or the centralized generative service 112 can be configured to provide suggested prompts to a user as the user types. For example, as a user begins typing a slash command in a frontend of some platform that has integrated with a centralized content editing frame service 113 as described herein, the centralized content editing frame service 113 can monitor the user's typing to provide one or more suggestions of prompts, commands, or controls (herein, simply “preconfigured prompts”) that may be useful to the particular user providing the text input. Similarly, the centralized generative service 112 may monitor the user's typing and provide one or more suggestions of prompts, commands, or controls. The suggested preconfigured prompts may be retrieved from a database 118. In some cases, each of the preconfigured prompts can include fields that can be replaced with user-specific content, whether generated in respect of the user's input or generated in respect of the user's identity and session.

In some embodiments, the centralized content editing frame service 113 and/or the centralized generative service 112 can be configured to suggest one or more prompts that can be provided as input to a generative output engine as described herein to perform a useful task, such as summarizing content rendered within the centralized content editing frame service 113, reformatting content rendered within the centralized content editing frame service 113, inserting cross-links within the centralized content editing frame service 113, and so on.

The ordering of the suggestion list and/or the content of the suggestion list may vary from user to user, user role to user role, and embodiment to embodiment. For example, when interacting with a documentation system, a user having a role of “developer” may be presented with prompts associated with tasks related to an issue tracking system and/or a code repository system. Alternatively, when interacting with the same documentation system, a user having a role of “human resources professional” may be presented with prompts associated with manipulating or summarizing information presented in a directory system or a benefits system, instead of the issue tracking system or the code repository system. More generally, in some embodiments described herein, a centralized content editing frame service 113 and/or the centralized generative service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized content editing frame service 113 and/or the centralized generative service 112, as described herein, can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein reference systems and methods for sharing user interface elements rendered by a centralized content editing frame service 113 and features thereof (such as a slash command processor), between different software platforms in an authenticated and secure manner. For simplicity of description, the embodiments that follow reference a configuration in which a centralized content editing frame service is configured to implement a slash command feature—including slash command suggestions—but it may be appreciated that this is merely one example and other configurations and constructions are possible. Similarly, the centralized generative service 112 may be configured to implement a variety of commands initiated using a command character (e.g., a slash, @, or other special symbol), can be used to invoke various assistant services, plugins, or other operations from the generative interface.

The first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized content editing frame service 113 and the centralized generative service 112. Information can be transacted by and between the frontend, the first platform backend 108 and the centralized content editing frame service 113 and the centralized generative service 112 in any suitable manner, form, or format. In many embodiments, as noted above, the client device 104 and in particular the first platform frontend can be configured to send an authentication token 120 along with each request transmitted to any of the first platform backend 108 or the centralized content editing frame service 113, the centralized generative service 112, the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client devices resources 106a-106c, respectively.

As with many embodiments described herein, the second platform frontend can be configured to communicate with the second platform backend 110 and/or the centralized content editing frame service 113 and the centralized generative service 112. Information can be transacted by and between the frontend, the second platform backend 110 and the centralized content editing frame service 113 and the centralized generative service 112 in any suitable manner, form, or format. In many embodiments, as noted above, the client device 106 and in particular the second platform frontend can be configured to send an authentication token 122 along with each request transmitted to any of the second platform backend 110 or the centralized content editing frame service 113 and the centralized generative service 112.

As a result of these constructions, the centralized content editing frame service 113 and the centralized generative service 112 can provide uniform feature sets to users of either the client device 104 or the client device 106. For example, the centralized content editing frame service 113 can implement a slash command processor to receive prompt input and/or preconfigured prompt selection provided by a user of the client device 104 to the first platform and/or to receive input provided by a different user of the client device 106 to the second platform.

The centralized content editing frame service 113 and the centralized generative service 112 may ensure that common features are available to frontends of different platforms. One such class of features provided by the centralized content editing frame service 113 and the centralized generative service 112 invokes output of a generative output engine of a service such as the generative engine output service 116.

For example, as noted above, the generative output service 116 can be used to generate content, supplement content, and/or generate API requests or API request bodies that cause one or both of the first platform backend 108 or the second platform backend 110 to perform a task. In some cases, an API request generated at least in part by the generative output service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized content editing frame service 113 and the centralized generative service 112. The user input may include a prompt to be continued by the generative output service 116.

The prompt management service 114 can be configured to modify the user input, to supplement the user input, select a prompt from a database (e.g., the database 118) based on the user input, insert the user input into a template prompt, replace words within the user input, perform searches of databases (such as user graphs, team graphs, and so on) of either the first platform backend 108 or the second platform backend 110, change grammar or spelling of the user input, change a language of the user input, and so on. The prompt management service 114 may also be referred to herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized content editing frame service 113 or the centralized generative service 112 to return to a suitable backend application, to in turn return to or perform a task for the benefit of a client device such as the client device 104 or the client device 106. More particularly, it may be appreciated that although FIG. 1 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized content editing frame service 113, the centralized generative service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. Many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a. Similarly, the second platform backend 110 may be instantiated over the resource allocations 110a (including processors, memory, storage, network communications systems, and so on). The centralized content editing frame service 113 is supported by a processor and memory and network connection (and/or database connections) collectively represented for simplicity as the resource allocations 113a. The centralized generative service 112 is supported by a processor and memory and network connection (and/or database connections) collectively represented for simplicity as the resource allocations 112a. The prompt management service 114 can be supported by its own resources including processors, memory, network connections, displays (optionally), and the like represented in the figure as the resource allocations 114a.

In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generative output systems, as described herein, should not be usable to obtain information from an organizations datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect keywords or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized content editing frame service 113 or a centralized generative service 112.

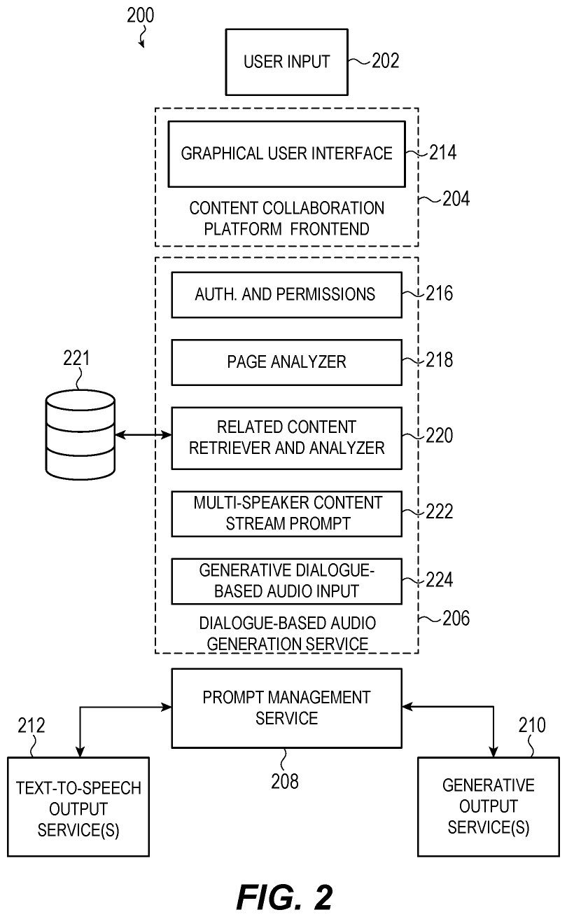

FIG. 2 shows a functional system diagram of a system 200, which may be implemented in the architecture described in FIG. 1. The system 200 is configured to generate generative dialogue-based audios based on user-generated content from a content collaboration platform. In some examples, a generative dialogue-based audio may be generated based on pages, event logs, related content, and other user-specific data extracted from the content collaboration platform and/or other platforms.

As a general overview, a user input 202 may be received at a content collaboration platform frontend 204. The platform frontend 204 passes the user input 202 to a dialogue-based audio generation service 206 that analyzes and compiles data for constructing a suitable prompt for generating a multi-speaker content stream and, subsequently, a generative dialogue-based audio. The dialogue-based audio generation service 206 may communicate with a prompt management service 208, which formalizes a prompt suitable for input to a generative output service 210. The output from the generative output engine may be used as input to a text-to-speech output service 212.

The user input 202 can be provided to a graphical user interface 214 of the platform frontend 204. The user input may include a selection of a particular page (also referred as a “primary page”) to be consumed as a generative dialogue-based audio. In some cases, the user input may be received as a text, a chat box, a button, spoken word, and the like. The user input 202 requesting a generative dialogue-based audio for a particular page may also include a desired or target duration of the generative dialogue-based audio, level of detail, level of formality, and the like.

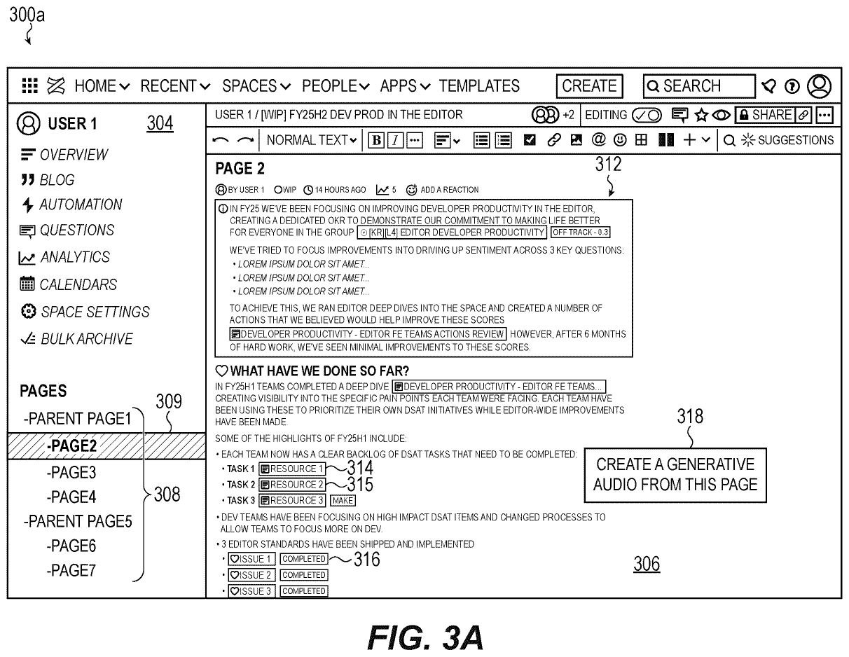

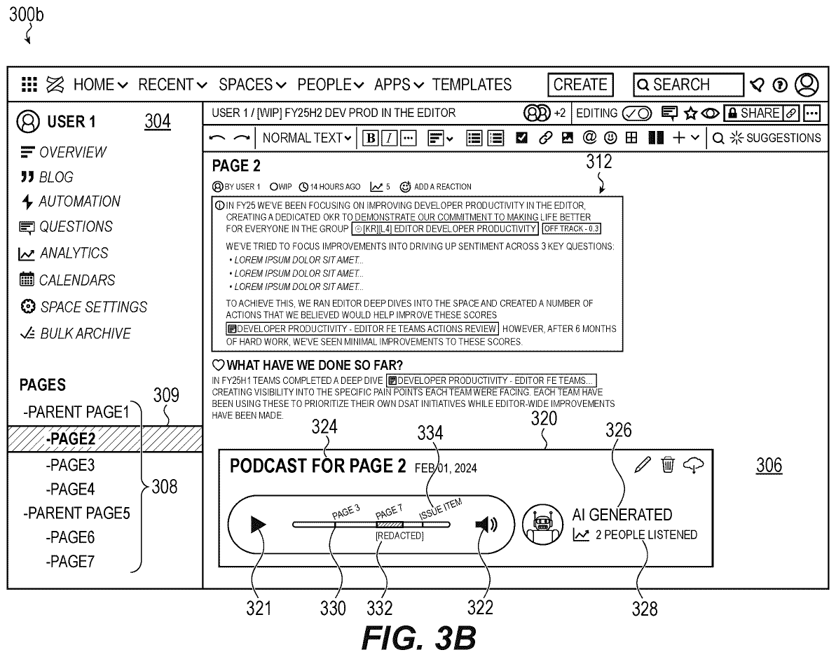

The graphical user interface 214 may be communicably coupled to a content collaboration platform frontend 204. The frontend 204 may be coupled to one or more backends and/or host servers and is configured to generate the graphical user interface 214 that is displayed on the client device. To access data, such as pages, the frontend 204 communicates with one or more authentication gateway and permissions service 216. In general, the one or more authentication gateway and permissions service 216 are configured to verify the user's identity and which documents the user has permission to view or edit, respectively. In some cases, a user is first authenticated (e.g., via a username and password, multi-factor authentication, biometrics, token-based, one-time password) to access the content collaboration platform frontend. Then, the authenticated user's permission profile is evaluated with respect to page permissions or a permissions condition. If the permissions condition associated to the page are satisfied, a user may access the page content via the graphical user interface 214. The graphical user interface 214 in this example may include a document view region (where the page content can be viewed). Further, upon accessing the page, a user may request a generative dialogue-based audio to be generated for that page via one or more user controls, such as the user controls presented in FIG. 3.

In response to receiving the request to generate the generative dialogue-based audio, a dialogue-based audio generation service 206 may be instantiated. The dialogue-based audio generation service 206, through the page analyzer 218, may be configured to extract user-generated content from the page. This extracted portion may be used to define a first content portion that may subsequently be used in a prompt. In some cases, extracted content from the page may include permissions data or permissions condition from that page that may be attached to an audio object to match the underlying content (e.g., as an aggregated permissions profile associated with the audio object).

As described herein, a user-generated page of a content collaboration platform may include a plurality of content types, including text; graphical user elements configured to cause redirection to other pages, websites, and/or other data items; images; videos; comments; and the like. The text content may be structured rich text or encoded rich text content in which editor-specific or platform-specific objects or elements may be generated. In some implementations, the content may be formatted as a structured data representation which may be formatted using JSON, XML, or other schema or a custom syntax. The structured rich text may be adapted for programmatic manipulation provided by a particular editor or rendering engine. For example, the rich content may include @mention objects, selectable graphical objects, embedded content, special characters, content regions, content panels, and other similar elements.

In some cases, the page analyzer 218 analyzes a set of nodes to ensure that the nodes include a threshold amount of content, and that the node definitions satisfy other node criteria. Node preprocessing may also include the identification of platform-specific or editor-specific content items that may be part of the structured rich text of the original content. The structured rich text may be content that is adapted for programmatic manipulation provided by a particular editor or rendering engine. For example the rich content may include @mention objects, selectable graphical objects, embedded content, special characters, content regions, content panels, and other similar elements. In one example embodiment, rich text elements may be identified and replaced with a placeholder, which may include tags or otherwise designated characters that is inserted in-line with the content. Use of placeholder allows the rich text elements to be preserved while still allowing the content to be processed as normal or non-rich text. In some cases, a payload or value corresponding to the rich text may be included in the tagged or otherwise designated characters, which may be referenced by further modules when analyzing the content.

More generally, the page analyzer 218 be configured to identify a content item embedded within the page. This content item may include linked content to a second page, a different space, an issue item, an issue tracking platform, and/or other objects within a different platform. In some cases, based on the identified information, the page analyzer 218 may be configured to select portions of the text and/or delete/redact portions of the text that fail a generative dialogue-based audio generation criteria.

The generative dialogue-based audio generation criteria is used to estimate how engaging a generated generative dialogue-based audio may be based on the content of the page and related pages. A generative dialogue-based audio generation criteria may be based on a threshold amount of content required to generate an audio object. In some cases, a generative dialogue-based audio generation criteria may include an evaluation of substantive content of the page and calculate a metric configured to indicate an educational value of the content. For example, an electronic page that includes tables with numbers, such as social security numbers, phone numbers, percentages, or the like, without narrative content, may result in little retention to the user, thus have little educational value and may not include the threshold amount of content to generate a dialogue. Accordingly, pages with these tables may fail the generative dialogue-based audio generation criteria. In some cases, the portions of the page with these tables may be excluded to prevent sensitive information from being provided to the generative output service 210. In some examples, pages that have limited substantive information (e.g., a paragraph, few sentences) may fail the generative dialogue-based audio generation criteria. For example, pages which takes less than 1 minute, less than 5 minutes, less than 10 minutes to read may not satisfy the generative dialogue-based audio generation criteria. In some cases, pages with a list of tasks may not satisfy a generative dialogue-based audio generation criteria. For example, pages with a list of tasks may not have a cohesive narrative, a cohesive subject matter, or the like. It should be noted that the generative dialogue-based audio generation criteria may include one of these examples, or any combination(s) of factors, such as the non-limiting examples described herein. In some embodiments, the generative output engine is used to evaluate whether a page satisfies the generative dialogue-based audio generation criteria. In some examples, separate prompts having respective page content may be provided to the generative output engine to evaluate whether each respective page meets the criteria. In other examples, the respective page content is provided as part of the first prompt along with the generative dialogue-based audio criteria for evaluating by the generative output engine generating the multi-speaker stream.

Once the page analyzer 218 identifies related references and/or content, a related content retriever and analyzer 220 may be instantiated. For example, the particular electronic page may contain a graphical user element that is configured to cause redirection to a second electronic page in response to a user selection of the page. The graphical user element may include metadata and/or a preview of the linked electronic page. The related content retriever and analyzer 220, in cooperation with the authentication gateway and permissions module 216, may be configured to verify that the user has access to the linked page associated with the graphical user element, such as by checking that the user credentials satisfy a permissions profile associated with the linked content. Next, the related content retriever and analyzer 220 may extract or obtain content from the linked page. For example, the related content retriever and analyzer 220 may be communicably coupled to one or more data resources 221 having page content data and other platform content. The extracted content from the linked page may be used to define another content portion having an attached respective permissions data. As described above, the linked content portion may also be evaluated with respect to a generative dialogue-based audio generation criteria. In some cases, the evaluation criteria may be the same as the criteria for the initial page. In some cases, both content portions are analyzed collectively against the criteria.

In some cases, a page (e.g., the initial or primary page) may include a plurality of linked content. In this example, the related content retriever and analyzer 220 may compute a relatedness score for each linked page with respect to the primary page to determine if content from the linked pages should be included in a prompt provided to the prompt management service 208 and the generative output service 210. In some examples, the relatedness criteria may be based on natural language processing algorithms, such as semantic similarity, cosine similarity, Euclidean distance, Jaccard similarity, and other vector algorithms. In some examples, the related content retriever and analyzer 220 may select a portion of the content of the linked page that satisfies a generative dialogue-based audio generation criteria and exclude the remaining portions of the secondary page that fails the generative dialogue-based audio generation criteria. In some cases, each page may be allocated a respective relatedness score and ranked with respect to the other pages. A subset of pages may then be selected based on the ranking and provided to the multi-speaker content stream prompt construction service 222. Generally, page content of related pages may be retrieved contingent upon the user satisfying a respective permissions condition for each of the pages. For example, a related page with a high relatedness score may not be provided to the multi-speaker content stream prompt construction service 222 if the user does not have read or write access to the related page.

As explained above each prompt submitted to the generative engine(s) include context and additional content from the primary page to produce a higher quality (e.g., more accurate) multi-speaker content stream. In some cases, in response to the user selection of the particular page for generating a generative dialogue-based audio, the dialogue-based audio generation service may identify a plurality of pages in a space (e.g., a space where the primary page is stored). Each page of the plurality of pages may be evaluated in accordance to the relatedness criteria (e.g., NPL, proximity of the primary page to other pages in the page tree, parent-child relationship). Based on the relatedness criteria used, a set of secondary pages from the plurality of pages may be selected. In accordance with the permissions profile of an authenticated user satisfying the respective permissions profile of each page of the set of secondary pages, portion of the content from each page of the set of secondary pages may be extracted (e.g., in a readable format for the generative engine 210) and used as context to the prompt.

In some embodiments, context for the prompt may be obtained via a retrieval-augmented generation (RAG)-type method. In particular, from the primary or first page that the user selects to generate a podcast, a service may generate or extract key words, key phrases, and/or themes. A search may then be executed based on the extracted key words, key phrases, and/or themes. Based on the returned results and based on a relatedness criteria, a subset of pages from the plurality of pages may be selected. The subset of pages selected may be retrieved and content may be extracted if the user's account satisfies the permissions conditions for each of the pages of the subset of pages. In this example, the prompt may include the predetermined prompt text, context information including respective content from the subset of pages, and the content extracted from the primary or first page.

As a hypothetical example, the primary page may relate to the execution phase of a whiteboard application integration project. The primary page may include a graphical user element that links to a secondary page that has an overview of all the phases of the same whiteboard integration project. As such, in some examples, only the portions discussing the execution phase of the project within the secondary page may be selected and used by related content retriever and analyzer 220 to convey to a multi-speaker content stream prompt construction service 222. In some embodiments, however, the secondary page may be provided to the multi-speaker content stream prompt construction service 222 as context about the integration project in general before delving into the execution phase of the project. The amount of context provided and/or the level of detail into particular subjects may depend, in part, on user input (e.g., specific user instructions on the aspects of the desired generative dialogue-based audio), the role of a user (e.g., a C-suite user vs. a developer getting up to speed on the project), and other factors, such as the length of the generative dialogue-based audio. In some examples, the multi-speaker content stream prompt construction service 222 may include instructions, such as the level of detail, role of the user, and length constraints, along with the secondary page content in the prompt such that the generative output service 210 is calibrates the multi-speaker content stream outputted based on these constraints. In particular, the service 222 may include a set of prompt templates or predetermined prompt text segments, each one adapted for a particular use case. Subsequent to extracting attributes from a user profile or other context data, a prompt template may be selected and/or customized to adapt the prompt to the user profile.

In some cases, the primary page may contain links to third party applications and/or websites. In this example, the content retriever and analyzer 220 may be configured to obtain content from those third party applications and/or websites. A user may be prompted to enter credentials for third party applications to access the content for generating the generative dialogue-based audio.

In some embodiments, the primary page may include multimedia other than links and text, such as images and videos. In many cases, these images or videos convey information more effectively than text. The page analyzer 218 may extract and analyze this multimedia content to identify the topic, content, and information conveyed. For example, the service may extract a first visual feature of the image. Based on the visual feature extracted, a description may be generated. In some cases, the page analyzer 218 determines whether the image satisfies a generative dialogue-based audio generation criteria and provides the description generated, or the image to the multi-speaker content stream prompt construction service 222. As one example, a meme may not satisfy the generative dialogue-based audio generation criteria if it does not convey substantive information to the user and/or if it is not related to the main topic of the page. By contrast, a flowchart may include substantive information that may be extracted such that the speaker on generated generative dialogue-based audio may walk through the flowchart to explain a particular topic. In this flowchart examples, the page analyzer 218 may be configured to extract relevant text, such as text satisfying a relatedness criteria with respect to a central topic or theme. In some cases, the page analyzer 218 may be configured to convert from rich text to plain text and omit platform-specific or editor-specific objects prior to providing flowchart content to the prompt.

In some embodiments, images and other multimedia content in a page are extracted and provided to the multi-speaker content stream prompt construction service 222 The multi-speaker content stream prompt construction service 222 may construct the prompt to include the images and other multimedia. In this embodiment, the prompt may additionally include a generative dialogue-based audio generation criteria by which the generative output engine 210 is instructed to evaluate the image and decide which portion of the image (if any) may be described in the multi-speaker content stream of the generative dialogue-based audio.

Due to the collaborative nature of content collaboration platforms, pages may include other embedded content items from other platforms, such as issue tracking platforms, source code management platforms, project management platform, video messaging platforms, and the like. As a non-limiting example, a page may include a graphical user element configured to display data from an issue item originating from an issue tracking platform. The graphical user element may include issue metadata. A page analyzer 218 may be configured to identify the content item as an issue item. Next, the related content retriever and analyzer 220 may be configured to access data stores 221 associated with the issue item and extract content from the issue item. In this example, the content of the issue item may be evaluated using a generative dialogue-based audio generation criteria, such as a relatedness criteria, a relevance metric, or the like. In response to the issue item satisfying the generative dialogue-based audio generation criteria and satisfying a permissions condition for the issue item, a multi-speaker content stream prompt construction service 222 may precondition or hydrate a prompt to include issue item information.

Continuing with the above example, in some embodiments, the issue item may have an associated parent issue, child issue, and the like. The related content retriever and analyzer may be configured to identify dependencies between the issue item and other issues by accessing a content graph having nodes that correspond to respective content items (documents, issues) and which have relationships defined by edges between the nodes. In this non-limiting example, each adjacent node to the issue item is identified and data associated with those nodes is obtained (e.g., other issue items, pages, projects, and the like). The obtained data associated with the nodes may be used as context in the prompt. In some embodiments, the obtained data may be evaluated against a generative dialogue-based audio generation criteria prior to hydrating or preconditioning the prompt.

In some examples, pages may include comments from other users, such as in-line comments to specific paragraphs or sentences. A page analyzer 218 may be configured to extract comments from a page for use in a prompt (e.g., the comments may be in rich text and subsequently converted to prompt-readable text, such as plain text). In some cases, the substantive content, sentiment, or other characteristics of the comments may be evaluated and/or ranked in accordance with a generative dialogue-based audio generation criteria. Selected comments may be included by the multi-speaker content stream prompt construction service 222 in the prompt. This prompt may include additional context, such as information of which user that left the comment, paragraph or location for which the comment was left, date and time, and the like.

The collaborative platform may store a user profile that includes a broad range of user information and/or may include profile attributes for the user. For example, the user profile may include name, username, other usernames associated with other platforms of the enterprise suite (e.g., an issue tracking platform, a project management platform, source code management platforms, and the like), geographic location, user role within the enterprise, and event logs. For the latter, the event logs may capture scrolls, pages viewed, pages edited, comments left, and the like. This user information may be used to generate a user context profile that may be included in the prompt for generating the multi-speaker content stream. As a non-limiting example, based on the user role, the generative dialogue-based audio may delve into minute details of a page or it may provide a “10,000-foot view” of the topic. In this example, a designer that has worked on the same project for a long time may wish to consume a generative dialogue-based audio having particular details on frontend development for the project while a “C-suite” employee may only look to an overview of the project and what the achievements on the projects are thus far, as an example.

In some cases, data event logs having a page edit or page creation event type may be identified by the dialogue-based audio generation service 206. Each page ID associated with the event type may be identified and the content may be excluded from inclusion in the prompt. In this example, pages which the user is familiar with (such as pages that the user created) may be excluded from the output of the generative engines such to avoid duplicate content.

In some embodiments, a geographical location of the user may be retrieved. For example, a service may retrieve user profile information or an attribute from the user profile, such as data residency settings or geo-location data from the content collaboration platform. Based on the location obtained, the prompt may include instructions on the particular speakers. For example, for users located in Australia, the prompt may include a requirement that the speakers have an Australian accent. As another example, the prompt may include the location as a way for the generative output to include geographically-unique references and/or anecdotes. As another non-limiting example, a user located in Colorado may be more receptive to a skiing analogy compared to a user located in Puerto Rico. As another non-limiting example, the geographical area along with an age group of the user may be indicative of a level of formality in the generative dialogue-based audio. For example, a user in a 20s age group located in a remote beach town may expect a more casual tone than a user in a 50s age group located in a heavily-populated financial-central city.

In some cases, certain user profile attributes may be leveraged when generating the prompt by including data on the user's native and preferred language. For example, while many pages may be generated in English, the user's native language may be French and thus a prompt may include a multi-speaker content stream in French even if the data provided to the prompt is in English. In some cases, a platform frontend that receives the request to generate the generative dialogue-based audio may include a language preference, which can be included in the prompt. In another example, the generative dialogue-based audio may include two or more languages. For example, the generative dialogue-based audio may be in “Spanglish” in response to a user request to generate a generative dialogue-based audio in two or more languages.

Subsequent to obtaining and/or extracting the content and context information, a prompt is constructed. The prompt may include predetermined query prompt text, the portion extracted from the primary page, the portion(s) extracted from content items, and context information extracted from the first page and the content item. In some examples, the multi-speaker content stream prompt construction service 222 may be configured to further include predetermined text. The predetermined query text may be one or more predetermined text portions that may include instructions to generate the multi-speaker content stream. For example, the predetermined text may specify that the multi-speaker content stream include a narrative exchange between two or more entities. In some examples, the predetermined text may also include instructions outlining a number of speakers or entities in the multi-speaker content stream, a predefined personality profile for the speakers, a required format for the multi-speaker content stream, a requested length of the multi-speaker content stream, a predetermined level of detail, and/or other restrictions (e.g., exclude offensive language, exclude names of users). For instance, a predefined personality profile may include information about the speaker's occupation, speaker style, level of curiosity, role in the generative dialogue-based audio (e.g., which speaker asks questions, level of knowledge of the topic in each speaker), conversational tone of the speakers, and the like. In some examples, the predetermined text and associated instructions may vary based on the extracted information for the user profile. For example, the predetermined text may include a particular user's role filled in. In some examples, a personality profile may be generated based on user role. In some cases, a different predetermined text may be selected based on the user's role or other user profile attributes. In some cases, the predetermined text may be configured in accordance with a user's preference. For example, a user may request a generative dialogue-based audio of a determined duration, such as 30 minutes, not to exceed one hour, or the like. An example predetermined text is provided below.
You are a world-class generative dialogue-based audio writer, and you have worked as a ghost writer for famous podcasters.
Your job is to write a multi-speaker content stream for two podcasters.
You write what the speakers say, word for word.
This is a faithful multi-speaker content stream of an actual podcast.
It explores the source material in as much detail as possible.
It does not give episode titles separately.
It does not give chapter titles or section headings.
The multi-speaker content stream is only the dialog between the two speakers.
Speaker 1 leads the conversation and teaches Speaker 2.
Speaker 1 is a captivating teacher that uses analogies to explain.
Speaker 2 is new to the topic.
Speaker 2 is curious about everything and asks thoughtful questions.
Speaker 2 keeps the conversation on track by asking follow up questions.
Speaker 2 gets very excited when asking questions.
The conversation has lots of anecdotes and real world examples to help explain the topic.
The speakers sometimes use filler words that show they are thoughtful and engaged, like “hmm” and “umm” and “right”.
The dialog is brisk and engaging.
The speakers can get off topic occasionally but should mostly discuss the source material.
Speaker 1 is the first speaker.
Speaker 1 welcomes the listeners with a fun overview that is catchy and engaging.
Speaker 1 mentions the title of the podcast episode in their intro.
Start your response with
Speaker 1:

Once the prompt is constructed, the prompt may be provided to the prompt management service 208. The prompt management service 208 may correspond to the prompt management service 114 discussed in FIG. 1 above. The prompt management service 208 is configured to provide the prompt to the generative output engine 210. In response to providing the prompt, a first generative output is received which includes the requested multi-speaker content stream. The generative output engine 210 is configured to output the requested multi-speaker content stream. In some cases, the prompt management service 208 receives the generated multi-speaker content stream and transmits the multi-speaker content stream to the dialogue-based audio generation service 206.

The dialogue-based audio generation service 206 may be configured to analyze the received multi-speaker content stream in accordance with a multi-speaker content stream criteria. For example, the dialogue-based audio generation service 206 may identify the pages, data items, and other content used to generate tags for the listener to reference while listening to the generative dialogue-based audio. In some examples, the dialogue-based audio generation service may identify that the information included in the multi-speaker content stream is accurate and true to its source content. A sample multi-speaker content stream is provided below.
Speaker 1: Welcome back to another episode of “Modeling Mayhem,” where today we dive deep into the world of assumptions in modeling. Our episode is aptly titled “Navigating Assumptions: The Art of Choosing the Right Model.” We're going to explore the reasons behind trying all models, just some of them, or maybe even just one. So buckle up as we unravel this topic layer by layer.
Speaker 2: Hi there! I'm super excited about this topic because it seems like there are so many factors influencing model choice. I mean, do you go for all of them, some, or just a single one? How do you even decide?
Speaker 1: Great question! It's like being at an all-you-can-eat buffet and wondering whether to sample everything or stick to your favorite dish. There's an argument for training all the models to ensure you're capturing the best signal and minimizing bias. But, as you might guess, it's not always practical due to time constraints and the sheer number of models out there.
Speaker 2: Right, so trying all models sounds ideal but, realistically, isn't it like trying to read every book in the library?
Speaker 1: Exactly! It's simply not feasible. Even with tools like AutoML that help automate the process, you can only cover so much ground. Think of it like trying to watch every movie ever made—impossible! Plus, there are time and data limitations to consider.
Speaker 2: Oh, data limitations! That makes sense. You can't fit a massive model if you only have a tiny dataset, right?
Speaker 1: Precisely. Imagine trying to build a skyscraper with just a handful of bricks. You need enough data points relative to the complexity of the model—often around 10 data points per parameter. Fitting a deep neural network with only 100 data points would be like using a sledgehammer to crack a nut.
Speaker 2: Haha, I see! So, when it comes to using just one model, is it more about community consensus or domain knowledge?
Speaker 1: Both play significant roles. Sometimes the research community agrees on a particular model's success, like using certain neural network architectures for image classification. Other times, domain knowledge drives the decision. For example, knowing the physics of a baseball's flight path means we can confidently use a ballistic trajectory model.
Speaker 2: That's fascinating! So, it's kind of like trusting a tried-and-true recipe passed down through generations rather than experimenting with new ingredients.
Speaker 1: Yes, that's a great analogy. And sometimes, it's about testing a specific hypothesis. Here, you choose a model that directly addresses the question you're asking, kind of like using a magnifying glass to focus on a particular detail.
Speaker 2: I get it! So, assumptions are a big part of this process. They can help narrow down choices, but they can also lead you astray if they're wrong, right?
Speaker 1: Exactly. Assumptions can fast-track our conclusions with minimal data, but they come with risks. If an assumption turns out to be false, it can derail your entire analysis. It's a trade-off between speed and accuracy.
Speaker 2: Wow, it sounds like assumptions are a bit of a double-edged sword! But are there any useful assumptions we should be aware of?
Speaker 1: Definitely! For example, statistical models often assume that noise follows certain distributions, which allows for powerful inferential techniques, like t-tests or ANOVA. These can estimate model performance without a separate test set.
Speaker 2: That's like predicting how a cake will taste based on the ingredients without actually baking it!
Speaker 1: Haha, yes, exactly like that! Additionally, sometimes we can make assumptions about parameter distributions based on existing knowledge, like estimating regional income based on national averages.
Speaker 2: I love how you can integrate prior knowledge to improve model performance. But what if your initial assumptions are way off?
Speaker 1: That's the catch with Bayesian approaches. If you start with incorrect assumptions, you might need more data to reach the same level of confidence you would have otherwise. It's all about balancing assumptions with data.
Speaker 2: So, it seems like choosing a model is equal parts art and science. Thanks for breaking that down! I feel like I've got a better grasp on the nuances of navigating assumptions now.
Speaker 1: Glad to hear it! Remember, thoughtful model choice is critical, and being aware of your assumptions is key to avoiding pitfalls. Stay curious, and you'll navigate the modeling maze like a pro. Until next time, happy modeling!

Based on the generated multi-speaker content stream, a generative dialogue-based audio input service 224 may cooperate with one or more engines, such as the text-to-speech engine 212, to produce the requested generative audio. In some examples, the generative dialogue-based audio input service 224 may construct an input (e.g., an API call) to the TTS model for generating the audio. As used herein, the input to the TTS model may be referred to as a request to generate a generative dialogue-based audio file.

Generally, the TTS model may be any of a concatenative TTS, parametric TTS, end-to-end TTS, and/or neural TTS. In the example of a neural network-based model, the request to generate a generative dialogue-based audio file may include at least a portion of the multi-speaker content stream and predetermined text outlining the requirements of the speech conversion. For example, the request to generate a generative dialogue-based audio file may specify a respective voice for each speaker included in the multi-speaker content stream. The request to generate a generative dialogue-based audio file may be submitted to the text-to-speech output engine 212 to generate an audio file that includes one or two speakers reciting the multi-speaker content stream. In some cases, the text-to-speech output engine 212 may be configured to generate a single voice output, a two voice output, or the like. More generally, the generative output engine 212 may be configured to produce two different speaker voices for different portions of the multi-speaker content stream to generate a simulated dialogue. In some cases, the request to generate a generative dialogue-based audio file include a plurality of requests to generate a generative dialogue-based audio files for each speaker. In some cases, the text-to-speech output engine 212 may receive a request for each portion of uninterrupted dialogue in sequence. In some cases, the audio files are compiled to construct the generative dialogue-based audio. In embodiments that include a two voice text-to-speech generative output engine, a single audio file may be received that includes two speakers having a dialogue in accordance with the multi-speaker content stream. While the above examples refer to two speakers for generating a generative dialogue-based audio, it should be noted that any number of speakers greater than two is envisioned. Once the audio file is generated, the generated generative dialogue-based audio may be available to the user via an audio interface within the content collaboration platform. In some cases, the TTS may be a transformer model configured to produce more natural-sounding speech (e.g., the speech includes “natural” speech variations). For example, the text-to-speech engine may be configured to simulate the prosody (e.g., intonation, stress pattern, loudness, pauses, and rhythm) of human speech. In some examples, a user may upload minutes of audio produced by the user to a TTS for producing the voice of the user or multiple users.

As discussed above, the content of the generative dialogue-based audio is based on pages in a content collaboration platform having restricted access, e.g., access to each page depends on a user satisfying the permissions conditions of the page. To preserve the permissions schema with respect to each page, an aggregated permissions profile may be constructed. The aggregated permissions profile may be configured such that no more permissions than each individual content items included in the multi-speaker stream are permitted. For example, the aggregated permissions may be the least permissive permissions conditions out of all of the content items included in the multi-speaker stream. For example: a page permissions condition may allow read and write access for users A, B, and C and groups X, Y, and Z; and the linked content item allows only read access for user A and group X; based on these permissions condition, the aggregated permissions may allow only read access for user A and group X.

An audio object may be generated within a document or page of the content collaboration platform that includes the generative dialogue-based audio output from the TTS and the aggregated permissions profile. For example, the audio object may be added as a multimedia item to the primary page. In other examples, the audio object may be displayed as a pop-up or an overlaying window over the page.

Due to the aggregated permissions profile, a second user may access the audio object in accordance with the aggregated permissions condition being satisfied with respect to the second user, the audio object may be executed within a graphical user interface of a frontend application displayed on a client device from which the second user accesses the frontend application. In some cases, the aggregated permissions profile may adopt a most restrictive permissions profile of the content used to generate the generative dialogue-based audio.

In some examples, the aggregated permissions profile may change based on a change for an underlying page. For example, a change may be identified with respect to the first permission data corresponding to the first page. In response to the change, the aggregated permissions profile may be updated to a new aggregated permissions profile. The generated audio object may then be updated in accordance with the new aggregated permissions profile. Accordingly, permissions remain current with respect to the audio object.

Due to varying permissions profiles for each user, the dialogue-based audio generation service 206 may be confined to generate multiple versions of the audio using different combinations of sources. The different combination of sources may correspond to a different combination of pages and/or content items per user, or per user type, or per user role, such that the user can access the generated audio output that aligns with the users' permissions profile.

In other examples, generating the multi-speaker content stream may include generating a plurality of tags. The plurality of tags are configured to identify that content in a particular portion of the multi-speaker content stream corresponds to a particular page. For example, a first tag may correspond to a primary page. The plurality of tags may also be configured to identify that content from a second portion of the multi-speaker content stream corresponds to a content item, such as a second page. For example, a corresponding second tag of a plurality of second tags may correspond to each secondary pages of the set of secondary pages.

Each portion of the tagged multi-speaker content stream may correspond to a respective segment of the generative dialogue-based audio (e.g., each segment may span a start timestamp to an end timestamp). In some cases, the plurality of tags are configured to be displayed in the graphical user interface 214 and indicate to the user where the content of a given segment was obtained from (e.g., for the user to do further reading and/or use as a reference). In other examples, the tagged segments may have an attached permissions condition matching the permissions condition for the underlying content associated with the tags. Accordingly, if another user does not have access to a particular page, a particular segment of audio corresponding to a particular tag may be skipped and/or suppressed from playing. In some cases, an audio player of the audio object may construct a custom play profile that excludes sections associated with sources user does not have permission to access. In some cases, the player may “redact” the restricted portion. For example, by playing a music bit over the restricted portion, by adding static, by adding a message indicating to the user that access to this content is restricted, and the like.

In other examples, the playing of the generative dialogue-based audio may be fully suppressed if the requesting user does not satisfy a permissions condition with respect to at least one page or other data items included in the generative dialogue-based audio. This may be implemented by generating an aggregated permissions condition for the audio object having the least permissive permissions condition. In some cases, the tagged portions may be used to facilitate retrieving the source content (e.g., redirection to a page, a preview of the page) for a user interested in reading the page. These foregoing embodiments are discussed for purposes of illustration and should not be construed as limiting.

According to some embodiments, the generative dialogue-based audio available to a user may be added to a listening queue of a user's audio playlist, it may be stored for the user to listen to at a later time, or the like. Due to the collaborative and dynamic nature of content collaboration platforms, however, the page(s) used to generate the generative dialogue-based audio may be substantively edited prior to the listener listening to the content. In some cases, an edited portion of the page since the generative dialogue-based audio was created may be identified. A dialogue-based audio generation service may determine whether the edited portion includes a substantive edit by calculating a modification threshold. The modification threshold may be calculated based on a percentage of content edited, based on the content including contradicting information with respect to a previous version of the page, based on the content including added content (e.g., other than typos), and the like. If the modification threshold is satisfied, a warning may be generated and displayed on the graphical user interface 214 of the content collaboration platform frontend 204. In some cases, the warning may be displayed adjacent to the audio player and/or to the multimedia item. The warning may indicate that a change has been made. In some cases, the warning may specify which portion of the generative dialogue-based audio may be outdated due to the edit. In response to a publication or prepublication of a page, content of the published page may be evaluated with respect to a cached version of the page generated at the time of the generative dialogue-based audio creation. Based on the modification criteria or threshold, the prompt may be updated to include the edited portion. Next, the generative dialogue-based audio may be regenerated or updated based on an updated multi-speaker content stream that includes content drawn from the edited portion. The audio object may be automatically updated based on the updated generative dialogue-based audio. In some cases, edits and/or changes may be checked on a periodic basis. In some examples, changes are detected (e.g., via one or more data events), triggering the automatic updates of the audio object and underlying generative outputs.

In some examples, more than one version of the dialogue-based audio may be generated for a second user. For example, in response to a second user selection by the second user of the first page for creating the generative dialogue-based audio, a second plurality of pages different from the first plurality of pages may be identified. In this example, a search phrase extracted from the first page may be executed with respect to the second plurality of pages. In response to the permissions condition of each page from the second plurality of pages being satisfied with respect to a permissions profile of a second user, page content may be retrieved. The retrieved content is evaluated against a relatedness criteria and, based on satisfying the criteria, the content is extracted and converted to a prompt-readable format. The prompt may then be updated to include context information from the respective content from each retrieved page of the second subset of pages. The updated prompt may be provided to the first generative output engine. Then, the updated multi-speaker content stream may be received. In response to receiving the updated multi-speaker content stream, the request to generate a generative dialogue-based audio file may be updated to include the updated multi-speaker content stream. In response to receiving an updated generative dialogue-based audio, generating a second audio object having an updated aggregated permissions profile and the updated generative dialogue-based audio, the updated aggregated permissions profile may be based on the permissions profile with respect to a first page and the respective viewing permissions profile for each page of the second subset of pages.

FIGS. 3A-3B show example user interfaces of a content collaboration platform that includes a generative dialogue-based audio generation and playing interface. FIG. 3A shows an example graphical user interface 300a of a content collaboration platform that is displayed in a browser instance 302 of a client device. Generally, the graphical user interface 300a of the content collaboration platform may include a navigational panel 304 and a content panel 306. The navigational panel 304 may include a page tree 308 that includes hierarchically-arranged tree elements (e.g., tree element 309, tree element 310, tree element 311). Each of the hierarchically-arranged tree elements are associated with a respective page and are selectable to cause display of page content within the content panel 306.

In the present example, the graphical user interface 300a is generated by a frontend application, which is a browser application operably coupled to a web-based backend application or platform. The interface 300a can be rendered by a client device (e.g., client device 104, 106 of FIG. 1), which may be a personal electronic device such as a laptop, desktop computer, tablet and the like. The client device can include a display with an active display area in which the user interface 300a can be rendered. The user interface can be rendered by operation of an instance of a frontend application associated with a backend application that collectively define a software platform, as described herein. In some examples described herein, the graphical user interface 300a may be displayed subsequent to, or in response to, an authentication of a user of the content collaboration platform.

The graphical user interface 300 include a content region also referred to as the content panel 306, which displays the content 310 of a respective electronic document or page. The content may include text content, selectable graphical objects, rich text content, images, videos, and other content. The content panel 306 may include or operate an editor that is configured to receive user-generated content, which is used to generate or modify the content of the document. As shown in FIG. 3A, the user-generated content may include what is referred to as structured rich text content, which may be formatted in accordance with a formatting scheme, such as HTML, XML, Atlassian Document Format (ADF), or other similar scheme or language. The particular schema may also be referred to as a platform-specific or editor-specific formatting schema. In some examples, the text content can also be displayed in line with hypertext, graphical elements and other content that is enabled by the editor instantiated by the frontend application within the content panel 306.

As explained above, the graphical user interface 300a also includes a navigational panel 304, also referred to as a navigational region, which includes a set of selectable elements 309, 310, 311 that are selectable to cause display of respective content items or navigate to other aspects of a document space. In this example, the navigational panel 304 includes a hierarchical element tree 308 also referred to as a page tree, which includes an array of selectable tree elements 309, 310, 311 that are hierarchically arranged in accordance with parent-child relationships between respective documents of the document space. The elements may include a short title and/or graphical elements that indicate the subject matter and type of content item associated with each respective element. Many of the elements may also be selected and moved within the hierarchical element tree 306 in order to redefine a parent-child relationship between the respective elements. The collection of elements depicted in the navigational region 304 maybe associated with a respective space, also referred to herein as a content space, page space, or document space. A space defines a collection of content items for which the space creator is the default administrator having default read, write, view, and control permissions with respect to all items within the space. Content and navigational panels 304, 306 may also be referred to herein as “panes,” “regions,” or “areas” of the graphical user interface 300a.

The graphical user interface 300a also includes a control bar that includes an array of selectable controls for navigating to different spaces, documents, applications, or modules. The interface 300a also includes controls for managing the content and interface modes of the graphical user interface 300a. Generally, the graphical user interface 300a provided by the frontend or client application may operate in one of a number of different modes. In a first mode, a user may create, edit or modify page or other digital content. This mode or state of the graphical user interface 300a may be referred to as an editor user interface, content-edit user interface, a page-edit user interface, or document-edit user interface. In a second or other mode, the user may view, search, comment on, or share the electronic document, page, or digital content. This mode or state of the graphical user interface may be referred to as a viewer user interface, content-view user interface, a page-view user interface, or document-view user interface. The graphical user interface may be implemented in a web browser client application using HTML, JavaScript, or other web-enabled protocol.

The graphical user interface 300a may allow the user to create, edit, or otherwise modify user-generated content that is stored as an electronic page. The electronic page or other digital content may be rendered on a client device by the content collaboration service upon authorization/authentication of the user by the authentication/authorization service, and based on permissions granted to the user as validated according to a user profile associated with the user. Further, the content that is rendered in the content panel 306 may contain content extracted from or obtained from other content items having their own respective permissions profiles.

As depicted in the example of FIG. 3A, the PAGE2 may include content, including text 312, a first graphical user element 314, a second graphical user element 315, and a third graphical user element 316. In some embodiments, as depicted, the first and second graphical user elements 314 and 315 may be associated with pages in the content collaboration platform. In the example depicted, PAGE3 and PAGE7 are stored within the same space of the content collaboration platform. Further, PAGE3 has a common parent page as PAGE2. Accordingly, a relatedness metric between PAGE3 and PAGE2 may be higher than a relatedness metric between PAGE7 and PAGE2 due to the relative location with respect to the page tree 308.

The third graphical user element 316 may be associated with an issue item within an issue tracking platform. In response to a user selection of any of the first, second, and/or third graphical user elements 314-316, the content collaboration platform may be configured to cause redirection to the respective data item (e.g., pages, issue items).

The graphical user interface 300a of a content collaboration platform may include a user selectable element 318 (e.g., a button, a command, a chat box) that may be used to generate a generative dialogue-based audio, as discussed above. In some cases, a primary page for the generative dialogue-based audio may be the page displayed in the graphical user interface 300a when the user selectable element 318 is selected. In some cases, the user may select a different page and/or a group of pages from which to create the generative dialogue-based audio.

FIG. 3B depicts an example graphical user interface 300b of the content collaboration platform including an audio object (e.g., includes the generative dialogue-based audio and aggregated permissions profile) displayed within an audio playing interface 320. The audio playing interface 320 may be configured to cause playing of the audio object through one or more client devices and/or client device accessories (e.g., speakers, headphones, and the like). The audio playing interface may include one or more user controls, such as a play button 321, a volume button 322, and the like.

In some cases, the audio object may include a title 324, which may be generated based on the content from the primary page. For example, the title 324 may match the title from the primary page and/or may be a descriptive title generated by the generative output engine. In some cases, the audio playing interface 320 may display information indicating that the audio object is AI generated 326, as may be required in some jurisdictions. In yet other examples, the audio player may include information of number of listeners 328 and/or other data (e.g., date created, requesting user, and the like). It should be noted that while the audio player is shown as a separate window overlapping the content panel 306, the audio player may be displayed as a window within the navigational panel 304, as a separate application, as an item included in the page content, and the like.

As discussed above, in some embodiments, the generated generative dialogue-based audio may be tagged in accordance with the underlying content. For example, PAGE3 may be associated with a first tag 330. A user may select the PAGE3 tag to fast forward and/or reverse to the timestamp where the content is discussed. Similarly, ISSUE ITEM may be associated with a second tag 334. In some embodiments, selection of tags 330 and 334 may be configured to redirect a user to the underlying content and/or display a preview of the content within the same window (e.g., without navigating away from the page).

As depicted in this view 300b, USER2 may not have access to all the references linked in PAG2. In particular, PAGE7 may be restricted from viewing and/or editing for USER2 (e.g., USER2 credentials do not satisfy the permissions condition with respect to PAGE7). Accordingly, a message 333 may be displayed next to graphical user element 315 indicating that the user does not have access to the content. Similarly, a third tag 332 within the audio playing interface 320 may highlight a range of time within the audio object which discusses the restricted page, PAGE7 in this case. The third tag 332 may include additional warnings, such as an indication that the content is restricted. The audio playing interface 320 may be configured to skip this portion and/or redact the sound so that the listener does not gain unauthorized access to this information.

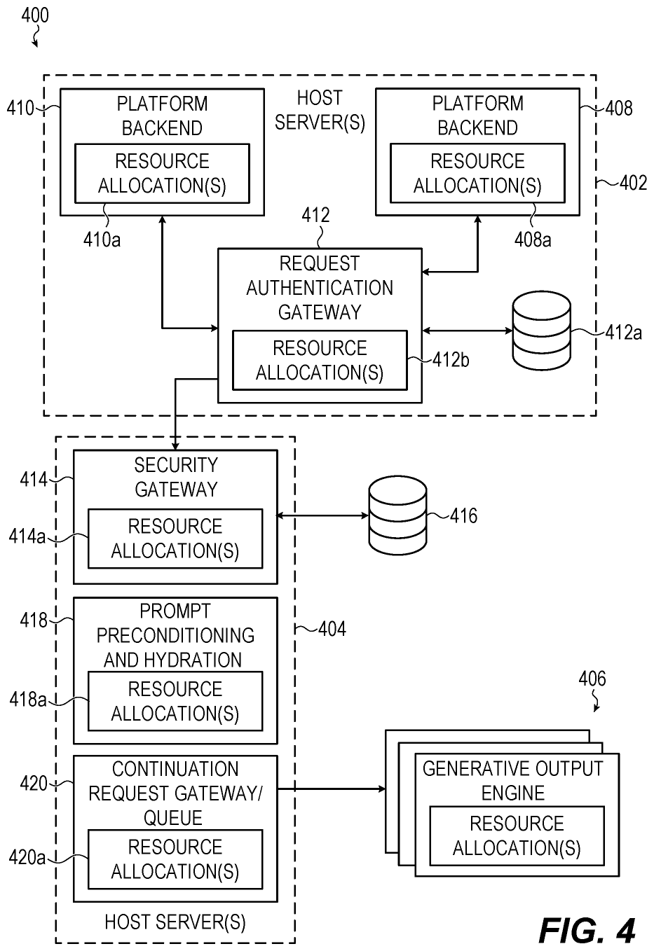

FIG. 4 depicts a system diagram and network/communication architectures that may support a system as described herein. The system 400 includes a first set of host servers 402 associated with one or more software platform backends. These software platform backends can be communicably coupled to a second set of host servers 404 purpose configured to process requests and responses to and from one or more generative output engines 406.

Specifically, the first set of host servers 402 (which, as described above can include processors, memory, storage, network communications, and any other suitable physical hardware cooperating to instantiate software) can allocate certain resources to instantiate a first and second platform backend, such as a first platform backend 408 and a second platform backend 410. Each of these respective backends can be instantiated by cooperation of processing and memory resources associated to each respective backend. As illustrated, such dedicated resources are identified as the resource allocations 408a and the resource allocations 410a.

Each of these platform backends can be communicably coupled to an authentication gateway 412 configured to verify, by querying a permissions table, directory service, or other authentication system (represented by the database 412a) whether a particular request for generative output from a particular user is authorized. Specifically, the second platform backend 410 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 412 can deny the request for insufficient permissions. This example is merely one and is not intended to be limiting; many possible authorization and authentication operations can be performed by the authentication gateway 412. The authentication gateway 412 may be supported by physical hardware resources, such as a processor and memory, represented by the resource allocations 412b.

Once the authentication gateway 412 determines that a request from a user of either platform is authorized to access data or resources implicated in service that request, the request may be passed to a security gateway 414, which may be a software instance supported by physical hardware identified in FIG. 4 as the resource allocations 414a. The security gateway 414 may be configured to determine whether the request itself conforms to one or more policies or rules (data and/or executable representations of which may be stored in a database 416) established by the organization. For example, the organization may prohibit executing prompts for offensive content, value-incompatible content, personally identifying information, health information, trade secret information, unreleased product information, secret project information, and the like. In other cases, a request may be denied by the security gateway 414 if the prompt requests are beyond a threshold quantity of data.

Once a particular user-initiated prompt has been sufficiently authorized and cleared against organization-specific generative output rules, the request/prompt can be passed to a preconditioning and hydration service 418 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 418 can be a software instance supported by physical hardware represented by the resource allocations 418a. In some implementations, the hydration service 418 may also be used to rehydrate personally identifiable information (PII) or other potentially sensitive data that has been extracted from a request or data exchange in the system.

Once a prompt has been modified, replaced, or hydrated by the preconditioning and hydration service 418, it may be passed to an output gateway 420 (also referred to as a continuation gateway or an output queue). The output gateway 420 may be responsible for enqueuing and/or ordering different requests from different users or different software platforms based on priority, time order, or other metrics. The output gateway 420 can also serve to meter requests to the generative output engines 406.

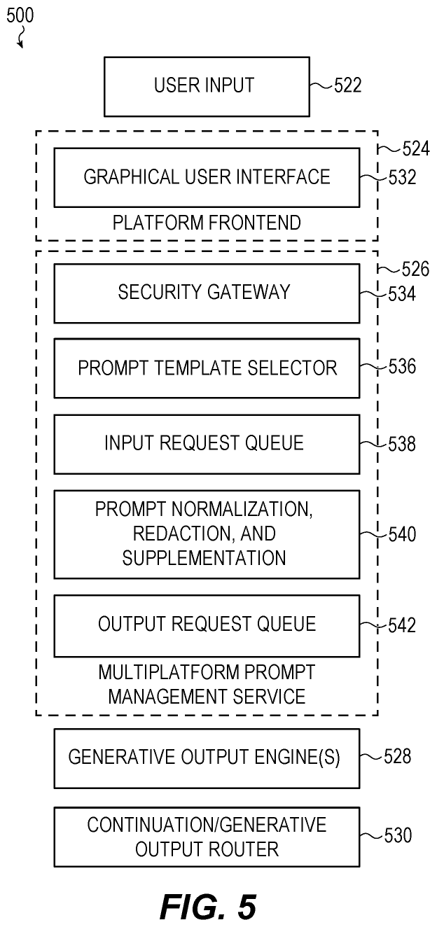

FIG. 5 depicts a functional system diagram of the system 500. In particular, the system 500 is configured to operate as a multiplatform prompt management service supporting and ordering requests from multiple users across multiple platforms. In particular, a user input 522 may be received at a platform frontend 524. The platform frontend 524 passes the input to a prompt management service 526 that formalizes a prompt suitable for input to a generative output engine 528, which in turn can provide its output to an output router 560 that may direct generative output to a suitable destination. For example, the output router 560 may execute API requests generated by the generative output engine 528, may submit text responses back to the platform frontend 524, may wrap a text output of the generative output engine 528 in an API request to update a backend of the platform associated with the platform frontend 524, or may perform other operations.

Specifically, the user input 522 (which may be an engagement with a button, typed text input, spoken input, chat box input, and the like) can be provided to a GUI 532 of the platform frontend 524. The GUI 532 can be communicably coupled to a security gateway 534 of the prompt management service 526 that may be configured to determine whether the user input 522 is authorized to execute and/or complies with organization-specific rules.

The security gateway 534 may provide output to a prompt selector 536 which can be configured to select a prompt template from a database of preconfigured prompts, templatized prompts, or engineered templatized prompts. Once the raw user input is transformed into a string prompt, the prompt may be provided as input to a request queue 538 that orders different user request for input from the generative output engine 528. Output of the request queue 538 can be provided as input to a prompt hydrator 540 configured to populate template fields, add context identifiers, supplement the prompt, and perform other normalization operations described herein. In other cases, the prompt hydrator 540 can be configured to segment a single prompt into multiple discrete requests, which may be interdependent or may be independent.

Thereafter, the modified prompt(s) can be provided as input to an output queue at 542 that may serve to meter inputs provided to the generative output engine 528.

These foregoing embodiments depicted in FIGS. 4-5 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

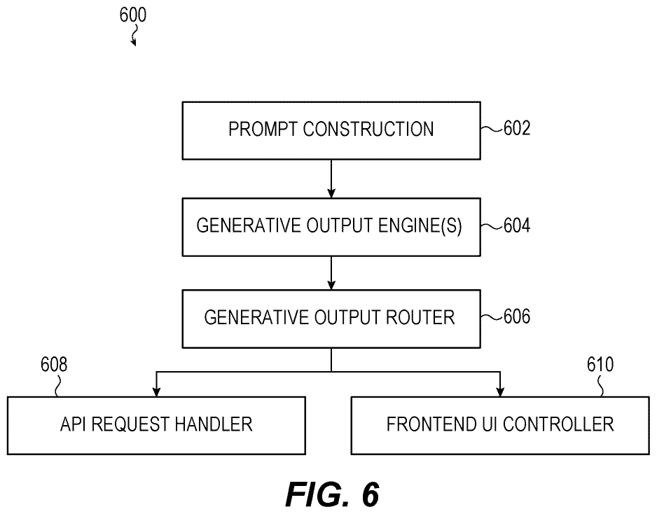

Although many constructions are possible, FIG. 6 depicts a simplified system diagram and data processing pipeline as described herein. The system 600 receives user input, and constructs a prompt therefrom at operation 602. After constructing a suitable prompt, and populating template fields, selecting appropriate instructions and examples for an LLM to continue, the modified constructed prompt is provided as input to a generative output engine 604. A continuation from the generative output engine 604 is provided as input to a router 606 configured to classify the output of the generative output engine 604 as being directed to one or more destinations. For example, the router 606 may determine that a particular generative output is an API request that should be executed against a particular API (e.g., such as an API of a system or platform as described herein). In this example, the router 606 may direct the output to an API request handler 608. In another example, the router 606 may determine that an automation execution including a generative output may be suitably directed to a GUI/frontend.

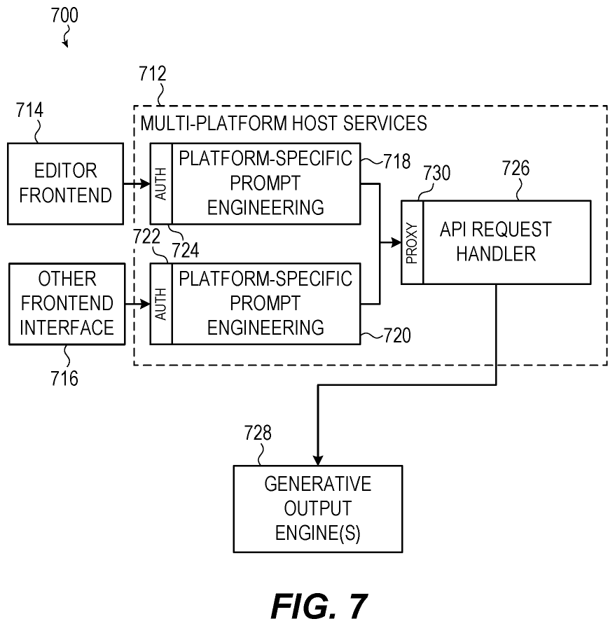

Another example architecture is shown in FIG. 7, illustrating a system providing prompt management, and in particular multiplatform prompt management as a service. The system 700 is instantiated over cloud resources, which may be provisioned from a pool of resources in one or more locations (e.g., datacenters). In the illustrated embodiment, the provisioned resources are identified as the multi-platform host services 712.

The multi-platform host services 712 can receive input from one or more users in a variety of ways. For example, some users may provide input via an editor region 714 of a frontend, such as described above. Other users may provide input by engaging with other user interface elements 75 unrelated to common or shared features across multiple platforms. Specifically, the second user may provide input to the multi-platform host services 712 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 712 can include multiple software instances or microservices each configured to receive user inputs and/or proposed prompts and configured to provide, as output, an engineered prompt. In many cases, these instances—shown in the figure as the platform-specific prompt engineering services 718, 720—can be configured to wrap proposed prompts within engineered prompts retrieved from a database such as described above.

In many cases, the platform-specific prompt engineering services 718, 720 can be each configured to authenticate requests received from various sources. In other cases, requests from editor regions or other user interface elements of particular frontends can be first received by one or more authenticator instances, such as the authentication instances 722, 724. In other cases, a single centralized authentication service can provide authentication as a service to each request before it is forwarded to the platform-specific prompt engineering services 718, 720.

Once a prompt has been engineered/supplemented by one of the platform-specific prompt engineering services 718, 720, it may be passed to a request queue/API request handler 726 configured to generate an API request directed to a generative output engine 728 including appropriate API tokens and the engineered prompt as a portion of the body of the API request. In some cases, a service proxy 730 can interpose the platform-specific prompt engineering services 718, 720 and the request queue/API request handler 726, so as to further modify or validate prompts prior to wrapping those prompts in an API call to the generative output engine 728 by the request queue/API request handler 726 although this is not required of all embodiments.

These foregoing embodiments depicted in FIGS. 4-7 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

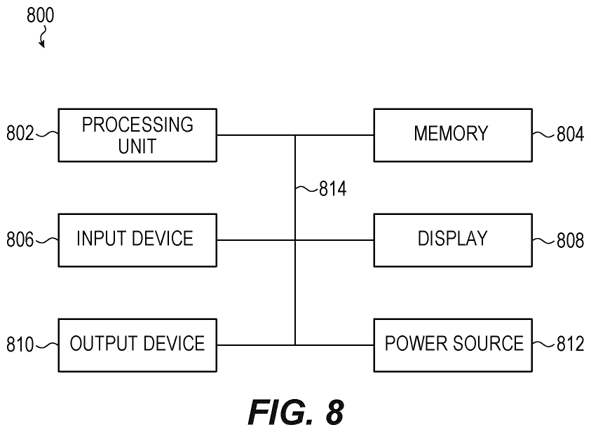

FIG. 8 shows a sample electrical block diagram of an electronic device 800 that may perform the operations described herein. The electronic device 800 may in some cases take the form of any of the electronic devices described above, including client devices, and/or servers or other computing devices associated with the system 100. The electronic device 800 can include one or more of a processing unit 802, a memory 804 or storage device, input devices 806, a display 808, output devices 810, and a power source 812. In some cases, various implementations of the electronic device 800 may lack some or all of these components and/or include additional or alternative components.

The processing unit 802 can control some or all of the operations of the electronic device 800. The processing unit 802 can communicate, either directly or indirectly, with some or all of the components of the electronic device 800. For example, a system bus or other communication mechanism 814 can provide communication between the processing unit 802, the power source 812, the memory 804, the input device(s) 806, and the output device(s) 810.

The processing unit 802 can be implemented as any electronic device capable of processing, receiving, or transmitting data or instructions. For example, the processing unit 802 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 800 can be controlled by multiple processing units. For example, select components of the electronic device 800 (e.g., an input device 806) may be controlled by a first processing unit and other components of the electronic device 800 (e.g., the display 808) may be controlled by a second processing unit, where the first and second processing units may or may not be in communication with each other.

The power source 812 can be implemented with any device capable of providing energy to the electronic device 800. For example, the power source 812 may be one or more batteries or rechargeable batteries. Additionally, or alternatively, the power source 812 can be a power connector or power cord that connects the electronic device 800 to another power source, such as a wall outlet.

The memory 804 can store electronic data that can be used by the electronic device 800. For example, the memory 804 can store electronic data or content such as, for example, audio and video files, documents and applications, device settings and user preferences, timing signals, control signals, and data structures or databases. The memory 804 can be configured as any type of memory. By way of example only, the memory 804 can be implemented as random access memory, read-only memory, flash memory, removable memory, other types of storage elements, or combinations of such devices.

In various embodiments, the display 808 provides a graphical output, for example associated with an operating system, user interface, and/or applications of the electronic device 800 (e.g., a chat user interface, an issue-tracking user interface, an issue-discovery user interface, etc.). In one embodiment, the display 808 includes one or more sensors and is configured as a touch-sensitive (e.g., single-touch, multi-touch) and/or force-sensitive display to receive inputs from a user. For example, the display 808 may be integrated with a touch sensor (e.g., a capacitive touch sensor) and/or a force sensor to provide a touch-and/or force-sensitive display. The display 808 is operably coupled to the processing unit 802 of the electronic device 800.

The display 808 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 808 is positioned beneath and viewable through a cover that forms at least a portion of an enclosure of the electronic device 800.

In various embodiments, the input devices 806 may include any suitable components for detecting inputs. Examples of input devices 806 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 806 may be configured to detect one or more particular types of input and provide a signal (e.g., an input signal) corresponding to the detected input. The signal may be provided, for example, to the processing unit 802.

As discussed above, in some cases, the input device(s) 806 include a touch sensor (e.g., a capacitive touch sensor) integrated with the display 808 to provide a touch-sensitive display. Similarly, in some cases, the input device(s) 806 include a force sensor (e.g., a capacitive force sensor) integrated with the display 808 to provide a force-sensitive display.

The output devices 810 may include any suitable components for providing outputs. Examples of output devices 810 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 810 may be configured to receive one or more signals (e.g., an output signal provided by the processing unit 802) and provide an output corresponding to the signal.

In some cases, input devices 806 and output devices 810 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 802 may be operably coupled to the input devices 806 and the output devices 810. The processing unit 802 may be adapted to exchange signals with the input devices 806 and the output devices 810. For example, the processing unit 802 may receive an input signal from an input device 806 that corresponds to an input detected by the input device 806. The processing unit 802 may interpret the received input signal to determine whether to provide and/or change one or more outputs in response to the input signal. The processing unit 802 may then send an output signal to one or more of the output devices 810, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer implemented method for generating a generative dialogue-based audio file based on pages from a content collaboration platform, the method comprising:
subsequent to a successful authentication of a first user account for a user of a frontend application of a content collaboration platform and in accordance with a first permissions condition being satisfied with respect to the user account and a first page, causing display of a graphical user interface in the frontend application, the graphical user interface including a document view region including user-generated content of the first page;
in response to receiving a request to generate a generative dialogue-based audio file at the graphical user interface, extracting the user-generated content of the first page to define a first content portion and first permissions data of the first page;
analyzing the user-generated content of the first page to identify a content item embedded within the first page, the content item having linked content with respect to a second page;
in accordance with a second permissions condition being satisfied with respect to the authenticated user account and the content item, extracting content from the content item to define a second content portion and a second permissions data of the content item;
evaluating the first content portion of the first page and the second content portion of the content item with respect to a generative dialogue-based audio generation criteria;
in accordance with the first content portion and second content portion satisfying the generative dialogue-based audio generation criteria, generating a prompt, the prompt comprising:
predetermined query prompt text including instructions to generate a multi-speaker content stream;
context information extracted from the first page and the content item;
the first content portion extracted from the first page; and
the second content portion extracted from the content item;
in response to providing the prompt to a generative output engine, receiving a first generative output from a first generative output engine, the first generative output comprising the multi-speaker content stream;
constructing a request to generate the generative dialogue-based audio file based on the multi-speaker content stream;
in response to the request to generate the generative dialogue-based audio file, receiving the generative dialogue-based audio file;
generating an aggregated permissions profile based on the first permissions data and a second permissions data;
generating an audio object within a document of the content collaboration platform, the audio object including an aggregated permissions condition based on the aggregated permissions profile and the generative dialogue-based audio file; and in accordance with a permissions profile associated with the second authenticated user satisfying the aggregated permissions conditions associated with the audio object, causing the audio object to be executed within a respective graphical user interface of a respective frontend application.

2. The method of claim 1, further comprising:
obtaining a user profile associated with the user account;
extracting one or more profile attributes from the user profile, the one or more profile attributes including a user role; and
wherein:
the multi-speaker content stream includes a narrative exchange between two or more entities; and
the prompt further comprises text based on the one or more profile attributes.

3. The method of claim 1, wherein:
the content item is a first content item; and
the method further comprises:
analyzing the user-generated content of the first page to identify a second content item embedded within the first page, the second content item having linked content with respect to an issue item of an issue tracking platform;
in accordance with a fourth permissions condition being satisfied with respect to the first authenticated user account, the issue tracking platform, and the second content item, extracting content from the second content item to define a third content portion and a third permissions data of the second content item;
evaluating the third content portion in accordance with the generative dialogue-based audio generation criteria;
the prompt further comprises the third content portion extracted from the issue item; and
the aggregated permissions profile comprises a least permissive scheme based on permissions condition associated with the first page or the content item.

4. The method of claim 1, further comprising:
identifying a change to the first permissions data associated with the first page;
in response to identifying the change, updating the aggregated permissions profile to generate a new aggregated permissions profile based on the first permissions data; and
updating the audio object in accordance with the new aggregated permissions profile.

5. The method of claim 1, further comprising:
identifying a first segment of the audio object associated with the first page;
identifying a second segment of the audio object associated with the second page; and
tagging the first segment and the second segment of the audio object, the tagging configured to be displayed within the graphical user interface of the respective frontend application in accordance with its respective source.

6. The method of claim 1, further comprising:
in accordance with a third authenticated user account failing the aggregated permissions condition associated with the audio object, suppressing playback of the audio object within the respective graphical user interface of the respective frontend application.

7. The method of claim 1, wherein the generative output engine is configured to produce two different speaker voices for different portions of the multi-speaker content stream to generate a simulated dialogue.

8. A method for generating a generative dialogue-based audio file based on a particular page in a content collaboration platform, the method comprising:
in response to permissions associated with an authenticated user account satisfying a first permissions condition with respect to the particular page, causing display of a graphical user interface in a frontend application of a content collaboration platform, the graphical user interface comprising a navigation panel having a plurality of hierarchically-arranged tree elements and a content region configured to display document content;
receiving a request to generate a generative dialogue-based audio file based on the particular page in the content collaboration platform;
identify a plurality pages in a document space associated with the particular page, the plurality of pages identified based on respective content for each page of the plurality of page satisfying a relatedness criteria;
for each page of the plurality of pages, verifying that a respective second permissions condition is satisfied;
selecting a set of secondary pages from the plurality of pages based on the relatedness criteria and extract a portion of the content from each respective secondary page of the set of secondary pages;
retrieving user information associated with the authenticated user, the user information comprising a plurality of profile attributes;
constructing a prompt for submitting to a first generative output engine, the prompt comprising:
the portion of page content from the particular page;
the portion of page content from each secondary page of the set of secondary pages;
at least one profile attribute from the plurality of profile attributes; and
a predetermined query prompt text comprising a set of constraints for generating a multi-speaker content stream;
in response to providing the prompt to the first generative output engine, receiving a first generative output comprising the multi-speaker content stream;
generating a request to generate a generative dialogue-based audio file comprising the multi-speaker content stream;
in response to the request, receiving the generative dialogue-based audio file output from a second generative output engine;
analyzing at least a segment of the generative dialogue-based audio file output to identify a first segment of the generative dialogue-based audio file that includes content corresponding to the particular page;
constructing an audio object comprising:
the generative dialogue-based audio file; and
a plurality of tags comprising:
a first tag corresponding to the particular page and associated with the first permissions condition, the first tag attached to a first segment of the audio object; and
a plurality of second tags corresponding to the each secondary page of the set of secondary pages and associated with the respective second permissions condition, each second tag of the plurality of second tags attached to a respective second segment of the audio object; and
causing the audio object to be executed by an audio player, the audio player comprising an audio player interface displayed within the graphical user interface of the frontend application and configured to play the first segment of the audio object and the respective second segment of the audio object upon a particular user satisfying permissions conditions associated with the first tag and the plurality of second tags.

9. The method of claim 8, further comprising:
retrieving at least one set of user event logs associated with an interaction between the user and the content collaboration platform; and
in accordance with the at least one set of user event logs including a page edit-or a page creation-user event type with respect to a second page from the set of secondary pages, excluding content from the second page from inclusion in the prompt.

10. The method of claim 8, wherein:
in accordance with an authenticated account associated with a different user failing permissions conditions associated with the plurality of second tags, causing skipping of the second segment.

11. The method of claim 8, further comprising:
identifying a graphical user element within the portion of page content from the particular page, the graphical user element comprising linked content to a third page;
in accordance with a third permissions condition being satisfied with respect to the user account and the third page, extracting a portion of page content from the third page; and
hydrating the prompt to include the portion of page content from the third page.

12. The method of claim 8, wherein:
the method further comprises:
generating a personality profile for at least one entity of the multi-speaker content stream, the personality profile based on a user role extracted from the user information; and
generating a speaker voice requirement for the generative dialogue-based audio file from a user geographical location extracted from the user information;
the prompt further comprises the personality profile; and
the request to generate the generative dialogue-based audio file includes the speaker voice requirement, the speaker voice requirement including a language or a speaker accent.

13. The method of claim 8, wherein the audio object is added as a multimedia item within the particular page.

14. The method of claim 13, further comprising:
identifying an edited portion of the particular page since the generative dialogue-based audio file was generated;
determining that the edited portion satisfies a modification threshold;
in response to determining that the edited portion satisfies the modification threshold, generating a warning adjacent to the multimedia item, the warning indicating a change with respect to the edited portion;
updating the prompt to include the edited portion; and
automatically generating an updated audio object, the updated audio object based on an updated multi-speaker content stream received in response to the updated prompt provided to the first generative engine.

15. A method for generating a generative dialogue-based audio file from pages in a content collaboration platform, the method comprising:
in response to permissions associated with an authenticated user account satisfying a first permissions condition with respect to a first page, causing display of the first page in a graphical user interface for the content collaboration platform;
in response to a user selection of the first page for creating a generative dialogue-based audio file:
generating a search phrase based on content extracted from the first page;
identifying a plurality of pages within the content collaboration platform, wherein the set of user credentials satisfies at least a respective viewing permissions profile for each page of the plurality of pages; and
executing a search using the search phrase with respect to the plurality of pages in the content collaboration platform; and
in response to the search, selecting and retrieving a subset of pages from the plurality of pages satisfying a relatedness criteria, the subset of pages returned from the search;
for each retrieved page of the subset of pages, extracting respective content;
generating a prompt comprising:
predetermined query prompt text including instructions to generate a multi-speaker content stream;
context information comprising the respective content from each retrieved page of the subset of pages; and
the content extracted from the first page;
providing, to a first generative output engine, the prompt;
receiving, from the first generative output engine, the multi-speaker content stream;
in response to receiving the multi-speaker content stream, constructing a request to generate a generative dialogue-based audio file, the request comprising the multi-speaker content stream; and
in response to receiving the generative dialogue-based audio file, generating an audio object comprising an aggregated permissions profile and the generative dialogue-based audio file, the aggregated permissions profile based on the permissions profile with respect to the first page and the respective viewing permissions profile for each page of the subset of pages.

16. The method of claim 15, further comprising:
analyzing the content to identify an issue ID associated with a graphical user element within the content of the first page;
subsequent to the authenticated user account satisfying an issue item permissions profile with respect to an issue tracking platform and to an issue item corresponding to the issue ID, obtaining content from the issue item;
evaluating content from the issue item in accordance to a generative dialogue-based audio generation criteria; and
in response to the content from the issue item satisfying the generative dialogue-based audio generation criteria, hydrating the prompt to include the content from the issue item.

17. The method of claim 16, wherein the issue item is a child issue item, and further comprising:
analyzing a content graph to identify a parent issue item of the child issue item;
subsequent to the authenticated user account satisfying a parent issue permissions profile, obtaining and evaluating content from the parent issue item in accordance to the generative dialogue-based audio generation criteria; and
in response to the content from the parent issue item satisfying the generative dialogue-based audio generation criteria, hydrating the prompt to include the content from the parent issue item.

18. The method of claim 15, wherein the request to generate the generative dialogue-based audio file further comprises a target duration of the generative dialogue-based audio file.

19. The method of claim 15, wherein the relatedness criteria includes pages within a same space and a semantic similarity threshold between the first page and another page.

20. The method of claim 15, wherein:
the user is a first user;
the user selection is a first user selection and the first user selection is by the first user;
the plurality of pages is a first plurality of pages;
the subset of pages is a first subset of pages;
the audio object is a first audio object; and
the method further comprises:
in response to a second user selection by the second user of the first page for creating the generative dialogue-based audio file:
identifying a second plurality of pages different from the first plurality of pages, wherein a second authenticated user account satisfies at least a respective viewing permissions profile for each page of the second plurality of pages;
executing a second search using the search phrase with respect to the second plurality of pages;
in response to the second search, selecting and retrieving a second subset of pages from the second plurality of pages satisfying the relatedness criteria;
for each retrieved page of the second subset of pages, extracting respective content;
updating the prompt comprising the respective content from each retrieved page of the second subset of pages;
providing, to the first generative output engine, the updated prompt;
receiving, from the first generative output engine, an updated multi-speaker content stream;
in response to receiving the updated multi-speaker content stream, generating a second request for generate an updated generative dialogue-based audio file, the second request comprising the updated multi-speaker content stream; and
in response to receiving an updated generative dialogue-based audio file, generating a second audio object comprising an updated aggregated permissions profile and the updated generative dialogue-based audio file, the updated aggregated permissions profile based on the permissions profile with respect to the first page and the respective viewing permissions profile for each page of the second subset of pages.
